(19) United States
(12) Patent Application Publication
(10) Pub. No.: US 2026/0302791 A1
(43) Pub. Date: Oct. 1, 2026

(54) ENERGY OPTIMIZATION APPARATUS

(71) Applicant: The Penn State Research Foundation, University Park, PA (US)

(72) Inventors: Jacob Seiler, University Park, PA (US); Gregory S. Pavlak, University Park, PA (US); James Freihaut, University Park, PA (US)

(73) Assignee: The Penn State Research Foundation, University Park, PA (US)

(21) Appl. No.: 19/631,468

(22) Filed: Mar. 27, 2026

Related U.S. Application Data
(60) Provisional application No. 63/779,343, filed on Mar. 28, 2025.

(51) Int. Cl. H02J 3/38; A01G 9/24; G05B 13/04; G06Q 30/0201; H02J 3/32

(52) U.S. Cl. CPC H02J 3/38; A01G 9/246; G05B 13/04; G06Q 30/0201; H02J 3/32

(57) ABSTRACT

An integrated energy management and optimization system for a controlled environment agriculture (CEA) facility includes at least one combined heat and power (CHP) unit and auxiliary technologies such as a thermal energy storage system, a battery energy storage system, a chiller, a cooling energy storage system, an exhaust treatment unit, and a carbon capture and utilization system. The system utilizes a multi-objective optimization algorithm, such as a mixed-integer linear programming (MILP) model, to control operation of the CUP and auxiliary systems based on demand inputs, market data, and real-time operational data. The optimization aims to minimize total costs and emissions while maximizing efficiency and market participation. The system can supply thermal energy, cooling energy, electricity, and treated CO₂ to the CEA, participate in energy and commodity markets, and incorporate waste heat recovery from secondary facilities such as data centers.

### CROSS-REFERENCE TO RELATED APPLICATIONS

This application claims priority to U.S. Provisional Patent Application No. 63/779,343, which was filed on Mar. 28, 2025. The entirety of this application is incorporated by reference herein.

### STATEMENT REGARDING FEDERALLY SPONSORED RESEARCH DEVELOPMENT

This invention was made with government support under Grant No. DE-EE0010961 awarded by the Department of Energy. The Government has certain rights in the invention.

### FIELD

The present disclosure relates to integrated energy management and optimization systems for controlled environment agriculture, with a focus on leveraging combined heat and power systems and auxiliary technologies to enhance efficiency, sustainability, and economic viability.

### BACKGROUND

The food-energy-water nexus is vital to human well-being but is currently under significant strain. The UN Food and Agriculture Organization (FAO) estimates that agriculture accounts for 70% of global freshwater use, while food production and supply contribute approximately 30% of global energy consumption. Growing demand driven by population increases, economic development, and technological advances exacerbates this pressure. Land degradation poses a critical threat and according to the Global Environment Facility (GEF) and the Intergovernmental Science-Policy Platform on Biodiversity and Ecosystem Services (IPBES), unsustainable agricultural practices cause an estimated loss of 24 billion tons of fertile soil annually. If unchecked, it is projected that 95% of the world's land could be degraded by 2050.

Controlled Environment Agriculture (CEA) offers promising solutions to these challenges. CEA can achieve crop yields comparable to traditional farming but with significantly less water, land, and chemical inputs. For example, hydroponic greenhouses produce equivalent yields on just 10% of the land and water used in conventional farming. Pesticide use can also be greatly reduced or eliminated. Additional benefits include improved product quality, proximity to urban markets, and year-round production, enabling fresh, local food regardless of climate.

Despite these advantages, CEA faces notable challenges. Its energy-intensive nature underscores the need for innovative, sustainable solutions that optimize energy use while balancing cost, efficiency, and/or environmental impacts. Although research on energy optimization in agriculture is advancing, gaps remain, particularly in comprehensive models tailored to the specific energy demands of CEA systems.

### SUMMARY

CEA is inherently energy-intensive, resulting in higher costs compared to conventional agriculture, despite savings from reduced transportation of foods and reduced stress on natural water systems due to traditional agriculture fertilizer run-off. Over 80% of greenhouse farm costs stem from energy, labor, management, and infrastructure. To mitigate these expenses, numerous technologies have been developed, including light emitting diodes (LEDs), variable frequency drives (VFDs), root-zone heating, and advanced energy systems such as combined heat and power (CHP), smart grids, thermal energy storage systems (TESS), battery energy storage systems (BESS), geothermal heating, carbon capture and utilization (CCU), photovoltaics, and heat pumps. The ultimate goal is to enable reliable, cost-effective, and sustainable food production that maximizes yield and quality while minimizing environmental impact. These technologies support efficiency improvements, load-shaping, and energy resale opportunities, but also pose complex operational and design challenges, such as identifying optimal technology combinations and operation strategies.

The unique characteristics of CEA create both challenges and opportunities. Energy demand is highly influenced by outdoor weather, indoor environmental setpoints, and operational choices. Fluctuations in energy costs and availability vary by location, contract, and market conditions. Additionally, CEA's specific requirement for CO₂ supplementation, often 2-3 times ambient levels during lighting, supports photosynthesis and crop growth, adding a distinctive energy input that is uncommon in other industries.

CEA's high onsite energy needs and demand flexibility offer significant advantages. Reliable energy sustains plant health, while operational flexibility, such as dimming or turning off lights in response to energy prices, can reduce costs without impairing crop growth. Meeting daily light integral (DLI) targets and respecting natural photo periods further complicate energy management but also present opportunities for load management.

CHP systems are particularly well-suited to CEA. They provide reliable, flexible power for lighting, fans, and pumps, producing heat that can be used directly or converted into cooling via absorption chillers. For hydrocarbon-fueled CHP units (e.g., natural gas), the exhaust contains CO₂, which can be utilized or captured for plant enrichment. CHP's efficiency advantage over separate heat and power (SHP) systems makes it more economical and environmentally friendly. Additional technologies like absorption cooling and CCU expand CHP's benefits.

CHP also enables energy export, creating revenue streams and supporting grid stability.

In renewable-heavy grids, dispatchable resources like CHP enhance resilience and decarbonization efforts. International examples, such as the Netherlands, demonstrate how CHP adoption, driven by energy market participation, can significantly reduce grid reliance and promote CO₂ utilization. Despite its proven benefits, CHP remains underutilized in U.S. agriculture, with only a small fraction of CHP installations serving the sector. The U.S. Department of Energy reports over 4,000 CHP units nationwide, but few are dedicated to agriculture, underscoring the potential for greater adoption given evolving market conditions and technological advances.

In response to these challenges and opportunities, the present disclosure introduces an integrated energy management and optimization system tailored for CEA. It leverages CHP and auxiliary technologies, including thermal storage, battery systems, absorption cooling, and carbon capture, to enhance efficiency, flexibility, and sustainability.

Additionally, in certain embodiments, waste heat from sources such as data centers can be recovered and supplied to the CEA, thus further improving overall utilization and efficiency. This interacting three component system—CHP, data center, and CEA—can relieve pressure on the central electric grid system struggling to meet data center growth electrical demand, while creating local area economic benefits via goods production and employment, which benefits stand-alone data centers do not address.

Central to this system is a multi-objective optimization model designed to concurrently manage multiple energy streams (e.g., electricity, heat, cooling, liquified CO₂, etc.) while explicitly considering their interactions. A key innovation is the integration of CO₂ generation, capture, and utilization, which is vital for maximizing crop growth and environmental performance. The model aims to optimize energy dispatch to minimize both costs and emissions, serving both design and real-time operational needs.

Furthermore, the system explores market participation by considering the export of multiple energy or material commodities, such as electricity, heat, CO₂, etc., enabling CEA operators to generate additional revenue and contribute to grid stability or other energy needs.

In an exemplary embodiment, an energy management and optimization system for a CEA facility includes at least one CUP unit that produces electricity, thermal energy, and CO₂ exhaust from a fuel source. The system further includes a plurality of auxiliary technologies including, but not limited to, a thermal energy storage system configured to receive, store, and discharge thermal energy, a battery energy storage system configured to receive, store, and discharge electricity, a chiller configured to convert thermal energy and/or electricity into cooling energy, a cooling energy storage system configured to receive, store, and discharge cooling energy, an exhaust aftertreatment unit configured to receive and treat the CO₂ exhaust, and to discharge treated CO₂, and a carbon capture and utilization system configured to receive, store, and discharge the treated CO₂ exhaust. The system further includes a control system in communication with the CUP unit and the auxiliary technologies. The CEA facility receives thermal energy, cooling energy, electricity, and CO₂ from the system. The control system receives inputs, executes a multi-objective optimization algorithm, and generates control signals to operate the CUP and auxiliary systems.

In some embodiment, the system further includes an electrical grid configured to supply electricity to the CEA facility and/or the battery energy storage system.

In some embodiments, the electrical grid is configured to receive electricity from the battery energy storage system.

In some embodiments, the multi-objective optimization algorithm includes an MILP model.

In some embodiments, the MILP model collects demand inputs of thermal energy, cooling energy, electricity, and CO₂ for the CEA facility, collects market data, collects real-time operational data from the CHP unit and auxiliary technologies, and determines control signals to operate the CHP unit and the auxiliary technologies based on an objective function.

In some embodiments, the market data includes one or more selected from the group consisting of market cost of electricity, market price for electricity to be sold, market cost of CO₂, market price for CO₂ to be sold, market cost of the fuel source, and market price for thermal energy to be sold.

In some embodiments, the objective function is

$$min {\sum }_{t = {t}_{i}}^{{t}_{f}} ( {w}_{cost} \cdot {Cost}_{net} [ t ] + {w}_{emissions} \cdot {Emissions}_{total} [ t ] ) ,$$

wherein t is time, tᵢ is an initial time, t_{f} is a predefined final time, w_{cost} is a predefined weight assigned to total costs, wₑₘᵢₛₛᵢₒₙₛ is a predefined weight assigned to total emissions, Costₙₑₜ is total costs, and Emissionsₜₒₜₐₗ is total emissions.

In some embodiments, the total costs are determined by Costₙₑₜ[t]=Cost_{NG} [t]+Cost_{E} [t]+Cost_{CO2} [t]−Sales[t], wherein Cost_{NG} is a cost of the fuel source, Cost_{E} is a cost of the electricity, Cost_{CO2} is a cost of the carbon dioxide, and Sales[t] is a market price at which electricity is sold multiplied by exported electricity.

In some embodiments, the total emissions are determined by Emissions_{Total}[t]=Emissions_{Onsite}[t]+Emissions_{Grid}[t]+Emissions_{CO2Buy}[t], wherein Emissions_{Onsite} is CO₂ produced from the CHP unit, Emissions_{Grid} is CO₂ produced from an electrical grid, and Emissions_{CO2Buy} is CO₂ purchased from an external source.

In some embodiments, the MILP model dynamically adjusts the control signals based on the real-time operational data.

In some embodiments, the system further includes a boiler configured to generate electricity and thermal energy from the fuel source.

In some embodiments, the chiller includes an absorption chiller configured to convert thermal energy into cooling energy; and/or an electric chiller configured to convert electrical energy into cooling energy.

In some embodiments, the system further includes a secondary facility that generates thermal energy.

In some embodiments, the system further includes a waste heat recovery heat pump configured to recover thermal energy from the secondary facility. The recovered thermal energy is supplied to the thermal energy storage system and/or the CEA facility.

In some embodiments, the secondary facility receives cooling energy and/or electricity from the system.

In some embodiments, the secondary facility is a data center.

Further features, aspects, objects, advantages, and possible applications of the present disclosure will become apparent from a study of the exemplary embodiments and examples described below, in combination with the Figures, and the appended claims.

### BRIEF DESCRIPTION OF THE DRAWINGS

The above and other objects, aspects, features, advantages, and possible applications of the present innovation will be more apparent from the following more particular description thereof, presented in conjunction with the following drawings. Like reference numbers used in the drawings may identify like components.

FIG. 1 is a schematic illustration demonstrating an exemplary integrated energy management and optimization system for controlled environment agriculture. The system simultaneously manages electricity, heating, cooling, and CO₂ utilization and storage.

FIG. 2 is a flow chart demonstrating an exemplary method of using a multi-objective mixed-integer linear programming (MILP) model to optimize operation of system technologies over a specified time horizon.

FIG. 3 is a diagram illustrating a first exemplary integrated energy management and optimization system.

FIG. 4 is a diagram illustrating a second exemplary integrated energy management and optimization system.

FIG. 5 is a table including technology input parameters and assigned values.

FIG. 6 is a table including decision variables and their limits.

FIG. 7 is a graph showing hourly electricity demand data points for a greenhouse.

FIG. 8 is a graph showing hourly heating demand data points for a greenhouse.

FIG. 9 is a graph showing hourly cooling demand data points for a greenhouse.

FIG. 10 is a graph showing hourly CO₂ demand data points for a greenhouse.

FIG. 11 is a graph showing hourly grid electricity price data used for the example.

FIG. 12 is a graph showing hourly natural gas price data used for the example.

FIG. 13 is a table including a case study scenario matrix.

FIG. 14 is a graph showing annual operational procurement costs and emissions for all scenarios with CHP and one auxiliary technology.

FIG. 15 is a graph showing annual operational procurement costs and emissions for all scenarios with CHP and two auxiliary technologies.

FIG. 16 is a graph showing heat and electricity production by CHP, a boiler, and a grid for all scenarios with two auxiliary technologies.

FIG. 17 is a graph showing procurement costs vs. boiler and CHP gas usage for scenarios with two auxiliary technologies.

FIG. 18 is a graph showing procurement costs vs. grid usage for scenarios with two auxiliary technologies.

FIG. 19 is a graph showing annual outcomes for different combinations of TESSH, BESS, and CCUS.

FIG. 20 is a graph showing annual energy procurement costs for CHP, TESSH, and BESS scenarios with different market price factors.

FIG. 21 is a graph showing TESSH and BESS discharge annual totals for CHPx1, TESSH, and BESS scenarios with different market price factors.

FIG. 22 is a graph showing an hourly electricity balance for March 20^{th} in the “CHPx1 TESSH BESS 80” scenario.

FIG. 23 is a graph showing hourly heat balance for March 20^{th} in the “CHPx1 TESSH BESS 80” scenario.

FIG. 24 is a graph showing hourly CO₂ balance for March 20th in the “CHPx1 TESSH BESS 80” scenario.

FIG. 25 is a graph showing the energy procurement cost differences between baseline scenarios and “CHP TESS” scenarios under various price adjustments with no electricity export available.

FIG. 26 is a graph showing energy procurement costs for “CHP TESS Export80” scenarios under various gas prices with electricity export available.

FIG. 27 is a graph showing energy procurement costs for “CHP TESS Export80” scenarios under various electricity prices with electricity export available.

FIG. 28 is a graph showing the energy procurement cost differences between baseline scenarios and “CHP TESS Export80” scenarios under various price adjustments with electricity export available and a constant MPF of 80%.

### DETAILED DESCRIPTION

The following description illustrates exemplary embodiments and methods of use that are presently contemplated for implementing the present invention. This description is not intended to be limiting, but rather to elucidate the general principles and features of various aspects of the invention. The scope of the invention is not restricted by this description.

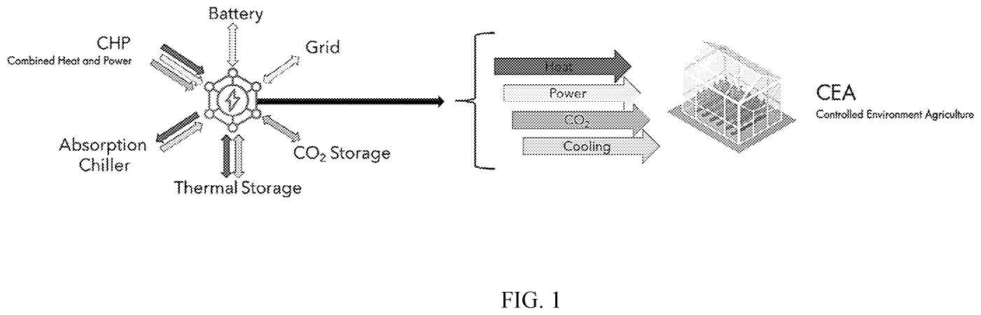

Embodiments relate to an integrated energy management and optimization system designed specifically for controlled environment agriculture (CEA) facilities, such as greenhouses, hydroponic farms, etc. In particular, referring to FIG. 1, the system concurrently manages multiple energy and material streams (e.g., electricity, heat, cooling, and CO₂) while considering their interactions.

An objective of this system is to optimize the operation of multiple technologies to minimize operational costs and greenhouse gas emissions, while simultaneously enabling active participation in energy or other commodity markets. This is achieved by intelligently designing and coordinating a suite of interconnected technologies, including one or more combined heat and power (CHP) units and one or more storage and utilization technologies (hereinafter “auxiliary technologies”), through a sophisticated multi-objective optimization framework. The system cam dynamically adjust control actions based on real-time data, forecasted demands, and/or market signals, ensuring cost-effective, sustainable, and resilient operation over time.

The system may be used in both design and operational applications. In design applications, a mixed-integer linear programming (MILP) model may be used to design a CEA facility that optimizes both costs and emissions.

In operational applications, the MILP model can be used to operate a CEA facility in an optimal manner. In such embodiments, as will be described in further detail, the CHP units and auxiliary technologies are each communicatively connectable to the MILP model and can be configured to provide real-time data to the model (e.g., via sensors or data acquisition devices). Similarly, the model can be configured to send control signals to the CHP units and auxiliary technologies such that the system operates in an optimal manner.

### Energy Management and Optimization System

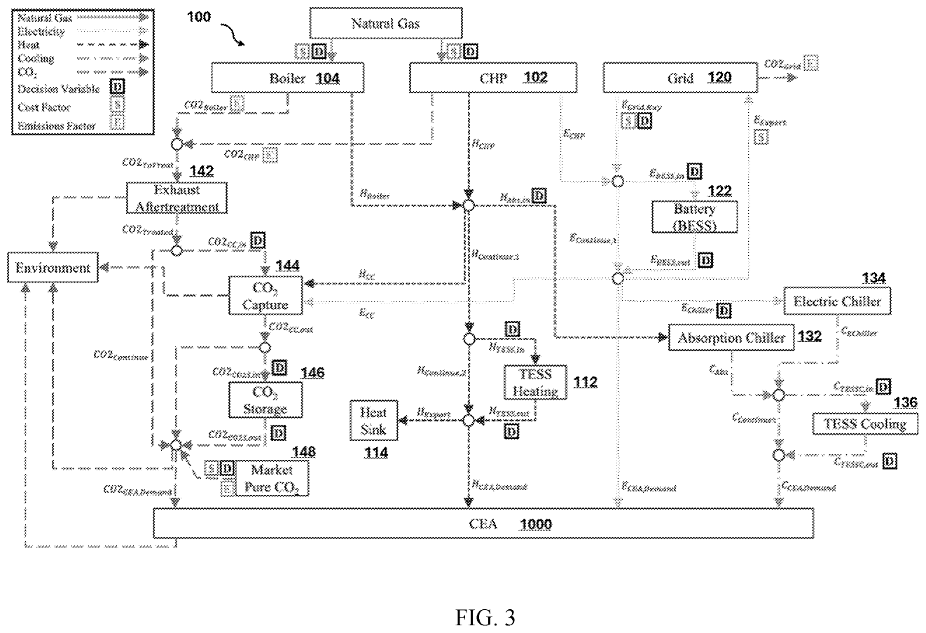

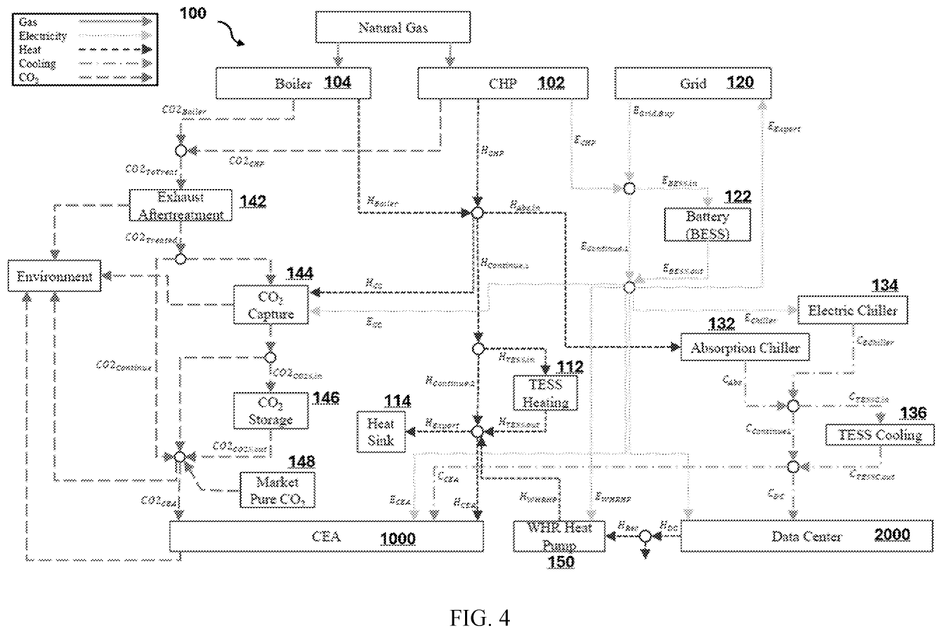

As seen in FIGS. 3 and 4, a system 100 controls the flow of electricity, heat, cooling, and CO₂ to meet the demands of a CEA facility 1000. The system 100 aims to minimize total operational costs, which can include fuel costs, electricity procurement, and potential revenue from exporting electricity or other commodities (e.g., heat, CO₂, etc.). The system 100 simultaneously aims to minimize greenhouse gas emissions, primarily CO₂ emissions resulting from fuel combustion and electricity generation.

The system 100 includes one or more CHP units 102. The CHP units 102 are configured to generate electricity and thermal energy from a fuel source, such as natural gas, biogas, or hydrogen. In particular, the CHP units 102 may provide electrical power directly to the CEA facility 1000 or export surplus electrical power to an electrical grid 120 and may further supply thermal energy for heating and optionally cooling (e.g., via absorption chillers 132) the CEA facility 1000. The electrical power can provide power for equipment such as lighting, fans, pumps, and other equipment, while the thermal energy can provide heat (or cooling) for climate control.

The CHP units 102 may advantageously operate at various load levels, with on/off controls, providing flexibility to match fluctuating energy demands within the CEA facility 1000.

It is understood that the CHP units 102 produce CO₂ as a byproduct of fuel combustion. This CO₂ can be utilized within the CEA facility 1000 for plant enrichment, reducing reliance on external CO₂ supplies, or stored for future use.

The system 100 may further include one or more boilers 104. The boilers 104 can be a supplemental heating component that also receives a fuel source. It can operate independently or in conjunction with the CHP units 102 to meet heating demands, especially during periods of low CHP output or high heating needs. The boiler units 104 may ensure reliable and continuous thermal energy supply.

Like the CHP units 102, the boilers 104 can also produce CO₂ as a byproduct of fuel combustion.

Accordingly, the system 100 concurrently manages multiple energy and material streams, including a heating (or thermal) stream, an electricity stream, a cooling stream, and a CO₂ stream.

### Heating (or Thermal) Stream

The heating stream receives thermal energy from the CHP units 102 and/or the boilers 104 (H_{CHP} and H_{Boiler}, respectively). At least a portion of the thermal energy (H_{CEA,Demand}) may be used to heat the CEA facility 1000.

In some embodiments, at least a portion of the thermal energy (H_{TESS,in}) may be supplied to one or more heating thermal energy storage systems (TESS) 112. The TESS 112 store excess thermal energy generated during periods of low demand or high generation. The TESS 112 may include insulated tanks or phase-change materials capable of holding heat for extended periods, though any apparatus configured to store and discharge thermal energy may be used.

The TESS 112 may be configured to discharge stored thermal energy (H_{TESS,out}) during peak demand or when onsite (e.g., CUP/boiler) generation is insufficient. The TESS 112 may then recharge during surplus conditions. The TESS 112 may additionally or alternatively be configured to discharge stored thermal energy (H_{Export}) to a heat sink 114. The heat sink 114 may include cooling towers and/or heat exchangers, though any dissipative device capable of releasing surplus thermal energy into the environment may be utilized.

In some embodiments, at least a portion of the thermal energy (H_{Abs,in}) may be supplied to an absorption chiller 132.

In some embodiments, at least a portion of the thermal energy (H_{CC}) may be supplied to a carbon capture and utilization system (CCUS) 144.

In some embodiments, at least a portion of the thermal energy generated by the system 100 may be supplied to external systems or recipients. For example, a third-party buyer may purchase surplus thermal energy, enabling the system 100 to participate effectively in heat market export or district heating schemes. This transfer can be achieved through direct thermal piping, heat exchange agreements, or other transfer mechanisms suited for the specific infrastructure. Additionally, the system 100 may be configured to supply thermal energy to nearby industrial facilities, commercial buildings, or community heating networks. The system 100 can be designed to operate flexibly, adjusting the amount of thermal energy exported depending on market conditions and demand needs.

### Electricity Stream

The electricity stream receives electrical power (E_{CHP}) from the CHP units 102. At least a portion of the electrical power (E_{CEA,Demand}) may be used to heat the CEA facility 1000. The electricity stream may additionally or alternatively receive electrical power from an electrical grid 120.

In some embodiments, at least a portion of the electrical power (E_{BESS,in}) may be supplied to one or more battery energy storage systems (BESS) 122. The BESS 122 store electrical power for later use (E_{BESS,out}) and/or export to the electrical grid 120 (E_{Export}). For example, BESS 122 can be charged with surplus electricity, which can then be discharged to the CEA facility 1000 during high demand and/or to the electrical grid 120 when electricity prices are favorable. Similarly, CHP units 102 may send electrical power directly to the electrical grid 120. Accordingly, the system 100 may effectively participate in energy market export.

Ultimately, interaction with the electrical grid 120 allows the system 100 to import electricity when on-site generation (e.g., CHP/boiler) generation is insufficient and to export electricity during surplus conditions. Market data and signals may influence whether surplus power is sold to the electrical grid 120 or stored within the BESS 122.

In some embodiments, at least a portion of the electrical power (E_{Chiller}) may be supplied to an electrical chiller 134.

In some embodiments, at least a portion of the electrical power (E_{CC}) may be supplied to the CCUS 144.

### Cooling Stream

The cooling stream can receive thermal energy from the heating stream. For example, at least a portion of the thermal energy (H_{Abs,in}) may be supplied to the absorption chiller 132. Unlike electric chillers, which consume electricity, absorption chillers use thermal energy to produce cooling energy. This reduces the electrical load on the system, lowers electricity costs, and leverages waste heat that would otherwise be unused. At least a portion of the resulting cooling energy (C_{CEA,Demand}) may be used to cool the CEA facility 1000.

The cooling stream may additionally or alternatively receive electrical power from the electrical stream. For example, at least a portion of the electrical power (E_{Chiller}) may be supplied to the electrical chiller 134. At least a portion of the resulting cooling energy (C_{CEA,Demand}) may then be used to cool the CEA facility 1000.

In some embodiments, at least a portion of the cooling energy (C_{TESSC,in}) may be supplied to one or more cooling thermal energy storage systems (TESS) 136. The TESS 136 may include insulated tanks or phase-change materials capable of holding heat for extended periods, though any apparatus configured to store and discharge thermal energy may be used.

The TESS 136 store excess cooling energy generated during periods of low demand or high generation. The TESS 136 may be configured to discharge stored cooling energy (C_{TESSC,out}) during peak demand. The TESS 136 may then recharge during surplus conditions.

### CO₂ Stream

The CO₂ stream can receive CO₂ from the CHP units 102 and/or the boilers 104 (CO2_{CHP} and CO2_{Boiler}, respectively) as a byproduct of fuel combustion. The CO₂ may be supplied to an exhaust aftertreatment 142 (CO2_{To Treat}) to provide treated CO₂ (CO2_{Treated}). The exhaust aftertreatment 142 may include catalytic converters and/or scrubbers to clean the emissions, though any apparatus capable of treating the exhaust CO₂ may be utilized. At least a portion of the treated CO₂ may be used to meet the demands of the CEA facility 1000 (CO2_{CEA,Demand}). In such embodiments, the exhaust aftertreatment 142 can be important to ensure that the treated CO₂ avoids damaging the plants with CO emissions.

In some embodiments, at least a portion of the treated CO₂ can simply be released into the environment. In such embodiments, the exhaust aftertreatment 142 can be important to ensure that the treated CO₂ complies with environmental regulations.

In some embodiments, at least a portion of the treated CO₂ can be provided to the CCUS 144 (CO2_{CC,in}). Unlike the exhaust aftertreatment 142 which allows the CO₂ to continue as part of the exhaust stream, the CCUS 144 extract the CO₂ and create a pure, storable stream of CO₂ (CO2_{CC,out}). The CCUS 144 may therefore provide CO₂ to the CEA facility 1000, to CO₂ storage 146 (CO2_{COS,in}), and/or to the environment. In preferred embodiments, the CCUS 144 is powered via thermal energy (H_{CC}) from the heating stream and/or via electrical power (E_{CC}) from the electricity stream.

In some embodiments, market pure CO₂ 148 may be combined with the CO₂ discharged from the exhaust aftertreatment 142, the CCUS 144, and/or the CO₂ storage 146, to adjust the purity levels of the discharged CO₂.

In some embodiments, at least a portion of the treated CO₂ may be supplied to external systems or markets. For instance, the system 100 may transfer surplus treated CO₂ to nearby industrial facilities, commercial entities, or agricultural operations seeking CO₂ for plant enrichment or other purposes, through pipelines or other transfer mechanisms.

### Secondary Facility

Referring to FIG. 4, certain embodiments contemplate a secondary facility 2000 in addition to the CEA facility 1000. While the figure includes a data center as the secondary facility 2000, it is contemplated that any facility that employs electrical power and/or cooling energy during operation, and particularly those that generate thermal energy during operation, may be utilized instead.

In these embodiments, the secondary facility 2000 may receive electrical power (E_{DC}) from the electricity stream and cooling energy (C_{DC}) from the cooling stream. During operation, the secondary facility 2000 may generate thermal energy (H_{DC}), at least a portion of which (H_{Rec}) may be passed to a waste heat recovery (WHR) heat pump 150. In preferred embodiments, the WHR heat pump 150 is powered via electrical power (E_{WHRMP}) from the electricity stream.

The WHR heat pump 150 may provide thermal energy (H_{WHRMP}) to the TESS 112, to the heat sink 114, and/or to the CEA facility 1000.

### MILP Model

The system 100 further includes a MILP model 200 to control the CEA facility 1000, and more specifically to optimize costs and/or emissions of the CEA facility 1000. For example, the model 200 can determine optimal operation of the CHP units 102 and auxiliary technologies over a defined time period.

The CHP units 102 and auxiliary technologies are each communicatively connectable to the model 200 and can be configured to provide real-time data to the model 200 (e.g., via sensors or data acquisition devices). Similarly, the model 200 can be configured to send control signals to the CHP units 102 and auxiliary technologies such that the system operates in an optimal or preferred manner.

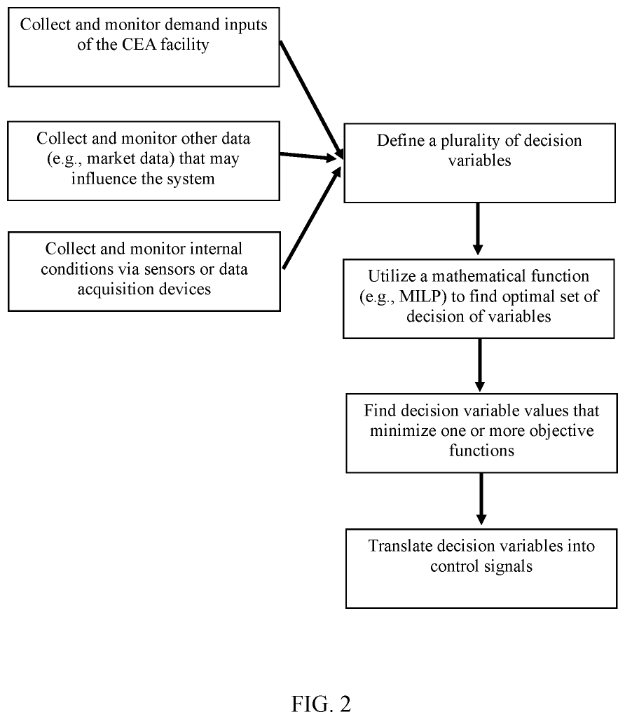

Referring to FIG. 2, the model 200 may collect and monitor demand inputs of the CEA facility 1000. The demand inputs include electrical demand (e.g., to power lighting, fans, pumps, etc.), thermal demand (e.g., for heating and cooling needs), and CO₂ demand (e.g., for plant enrichment. The demand inputs may further include external inputs, such as weather forecasts or environmental conditions, that may affect the demand inputs of the CEA facility 1000 and/or renewable generation potential.

The model 200 may also collect and monitor other data that can influence system operation. In some embodiments, market data such as electricity prices, fuel costs, and CO₂ prices can be collected. This data can be sourced from weather services, energy market operators, fuel suppliers, etc.

The model 200 may simultaneously collect and monitor internal conditions via sensors or data acquisition devices placed throughout the facility 1000 and technologies. The sensors can measure data including, but not limited to, the current status of CHP units (operation level, efficiency), storage systems (state-of-charge), environmental parameters (temperature, humidity, lighting, and solar illuminance levels), and other relevant system states. This real-time data can ensure that the optimization process is grounded in the actual system status.

Based on the collected inputs and data, the model 200 may define a plurality of decision variables, which are controllable parameters that the optimization will determine. Examples of such variables include, but are not limited to, electricity purchased from the electrical grid (E_{Grid,buy}), fuel purchased for the boiler (NG_{Boiler}), fuel purchased for the CHP unit (NG_{CHP}), CHP on/off switch (Switch_{CHP}), CHP unit load percentage (LP_{CHP}), thermal energy delivered to TESS (H_{TESSH,in}, thermal energy received from TESS (H_{TESSH,out}), cooling delivered to TESS (C_{TESSC,in}), cooling received from TESS (C_{TESSC,out}), electrical power delivered to BESS (E_{BESS,in}), electrical power received from BESS (E_{BESS,out}), thermal energy delivered to absorption chiller (H_{AbS,in}), CCUS on/off switch (Switch_{CC}), amount of exhaust CO₂ sent to CCUS (CO2_{CC,in}) market pure CO₂ purchased (CO2_{Purchased}), CO₂ delivered to storage (CO2_{CO2S,in}), CO₂ received from storage (CO2_{CO2S,out}), and/or the like.

The model 200 may then utilize a mathematical formulation (i.e., a MILP) to find the best set of decision variables. This involves constructing one or more objective functions that i) minimize total operational costs (fuel, electricity, and market transaction costs) and/or ii) minimize total greenhouse gas emissions (primarily CO₂). These objectives can be combined into a weighted sum, allowing the system operator to prioritize one goal over another as needed:

$$min {\sum }_{t = {t}_{i}}^{{t}_{f}} ( {w}_{cost} \cdot {Cost}_{net} [ t ] + {w}_{emissions} \cdot {Emissions}_{total} [ t ] ) \qquad ( 1 )$$

wherein t is time, tᵢ is an initial time, t_{f} is a predefined final time, w_{cost} is a predefined weight assigned to total costs, wₑₘᵢₛₛᵢₒₙₛ is a predefined weight assigned to total emissions, Costₙₑₜ is total costs, and Emissionsₜₒₜₐₗ is total emissions.

The total costs can be determined through the following equations:

$${Cost}_{NG} [ t ] = {P}_{NG} [ t ] \cdot ( {NG}_{Boiler} [ t ] + {NG}_{CHP} [ t ] ) \qquad ( 2 )$$

$${Cost}_{E} [ t ] = {P}_{E , buy} [ t ] \cdot {E}_{Grid , buy} [ t ] \qquad ( 3 )$$

$${Cost}_{CO 2} [ t ] = {P}_{CO 2} [ t ] \cdot {CO2}_{Buy} [ t ] \qquad ( 4 )$$

$${P}_{E , sell} [ t ] = {P}_{E , buy} [ t ] \cdot MPF \qquad ( 5 )$$

$$Sales [ t ] = {P}_{E , sell} [ t ] \cdot {E}_{Export} [ t ] \qquad ( 6 )$$

$${Cost}_{net} [ t ] = {Cost}_{NG} [ t ] + {Cost}_{E} [ t ] + {Cost}_{CO 2} [ t ] - Sales [ t ] \qquad ( 7 )$$

where Cost_{NG} is the cost of fuel, P_{NG} is the market price of fuel, NG_{Boiler} is the fuel purchased for the boiler, NG_{CHP} is the fuel purchased for the CHP unit, COSt_{E} is the cost of electrical power, P_{E,buy} is the market price at which electricity can be bought, E_{Grid,buy} is the electricity purchased from the electrical grid, Cost_{CO2} is the cost of CO₂, P_{CO2} is the market price of CO₂, CO2_{Buy} is the purchased CO₂, P_{E,Sell} is the market price at which electricity can be sold, MPF is the market price factor (the fraction of the price to buy energy at which energy can be sold), and E_{Export} is the electricity exported to the electrical grid.

Additionally, the total emissions can be determined through the following equations:

$${Emissions}_{Onsite} [ t ] = {CO2}_{Onsite} [ t ] \qquad ( 8 )$$

$${Emissions}_{Grid} [ t ] = {E}_{Grid , buy} [ t ] \cdot {GER}_{CO 2 e} \qquad ( 9 )$$

$${Emissions}_{CO 2 , Buy} [ t ] = \frac{{CO2}_{Buy} [ t ]}{{η}_{CO 2 Attainment}} \qquad ( 10 )$$

$${Emissions}_{Total} [ t ] = {Emissions}_{Onsite} [ t ] + {CO2}_{Grid} [ t ] + {Emissions}_{CO 2 Buy} [ t ] \qquad ( 11 )$$

where Emissions_{Onsite} is the emissions produced from the CHP units and/or boiler, CO2ₒₙₛᵢₜₑ, and is the CO₂ produced from the CHP units and/or boiler. Emissions_{Grid} is emissions produced by the regional electrical grid system that is emitting CO₂ₑ at a GER_{CO2e} rate when producing a certain quantity of electrical power purchased, E_{Grid,buy} Emissions_{CO2Buy} is the emissions from purchasing CO₂, CO2_{Buy} is the emissions that need to be purchased, and η^{CO2Attainment} is efficiency of capturing the emissions produced by the onsite CHP system for us in the CEA environment.

The formulation may also contemplate a set of constraints reflecting physical and operational limits. Constraints may include, but are not limited to, capacity limits of CHP units and storage systems, minimum and maximum operation levels, storage capacity and state-of-charge constraints, demand fulfillment for electricity, heat, cooling, and CO₂, market participation rules, such as maximum export limits; and/or system efficiencies and operational constraints.

The formulation can then be supplied to a solver (e.g., an advanced computational algorithm) to explore possible solutions. Specifically, the solver is configured to find the decision variable values that minimize the objective function(s). This process involves evaluating candidate solutions, respecting the constraints, and iteratively refining toward the optimal control set. The solver outputs the best solution, an optimal combination of control actions, specific to the upcoming operational interval.

The solver's output may then be translated into control signals to send to the system 100, and particularly to the CHP units 102 and auxiliary technologies. The control signals may specify how each system component should operate over a predefined time period. Control signals may include, but are not limited to, adjusting valve positions, switching system modes, or changing output setpoints. For example, the CHP units 102 and auxiliary technologies may each include hardware controllers, which manage the real-time operation of each device according to the control signals.

Once control signals are sent and enacted, the system 100 operated accordingly. During this phase, the sensors or data acquisition devices may continue to monitor actual system performance and environmental conditions to provide feedback to the model 200. This feedback verifies whether the system is functioning as intended, detects deviations, and provides updated data for the next optimization cycle.

Given the constantly changing environment and market conditions, the entire model process can be repeated at regular intervals, such as hourly, daily, etc. Each iteration begins with new data and input collection, followed by re-optimization, enabling the system 100 and model 200 to adapt dynamically. This continuous loop ensures that the energy management remains optimal over time, balancing costs and emissions while maintaining environmental control.

### EXAMPLES

A model was developed to simulate the movement and management of energy and resources across various demand types at CEA sites, including electricity, thermal energy, cooling power, and CO₂ supplementation. The model integrated a diverse set of technologies for energy generation, storage, and utilization, designed to meet demands and enhance system efficiency and performance. These technologies included the electrical grid, boilers, CHP units, CO₂ capture and utilization systems, electric chillers, absorption chillers, thermal storage for heating and cooling, CO₂ storage (CO2S), and battery storage. Additionally, it factored in the potential for selling surplus electricity back to the grid.

This example focuses strictly on the operational energy costs and revenues associated with energy procurement, management, and sales. It does not incorporate capital, maintenance, or overhead costs, as the goal was to optimize short-term energy dispatch rather than provide a full financial feasibility analysis.

### Methods—System Model

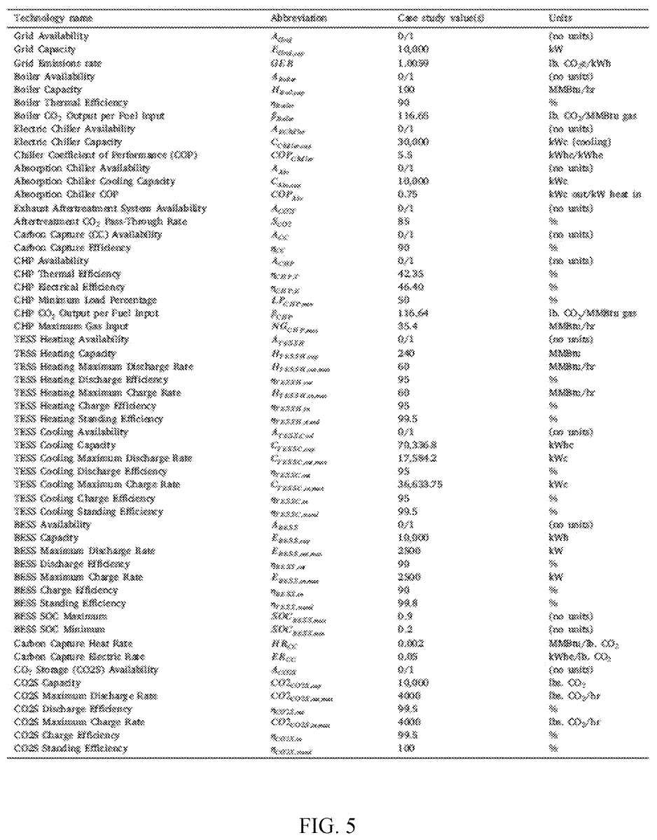

Technology Performance: Each technology was assumed to have certain performance characteristics that had to be accounted for in the model. This section details how their performance was modeled. A list of technology characteristics considered as well as the assumed values for the case study and the nomenclature/abbreviations used in this example are listed in FIG. 5. The grid, boiler, electric chiller, and the exhaust aftertreatment system were considered baseline technologies because these are some of the simplest and most common energy technologies found at high-tech CEA sites.

Baseline Technologies: The grid, boiler, and electric chiller were modeled with continuous variables, allowing them to operate at any load level from 0% to 100%. This flexibility was essential for baseline scenarios where these technologies can be solely responsible for meeting the varying demands of the CEA site, regardless of the scale. In practice, technologies like boilers and chillers can adjust their output dynamically, often using mechanisms such as variable frequency drives (VFDs) to modulate their power levels.

Alternatively, some systems can operate with constant output but cycle on and off to maintain the desired conditions within a tolerance range around a setpoint. In such cases, the load percentages in the model would represent the fraction of time a technology is active during a given time step (e.g., the percentage of an hour the system is running to meet demand). This approach ensured that the model captured the operational flexibility of these systems, either through variable output or time-based cycling.

The boiler was modeled with a constant efficiency (η_{Boiler}) and carbon conversion factor (β_{Boiler}), as thermal (H_{Boiler}) and CO₂ outputs (CO2_{Boilerer}) were a function of natural gas input (NG_{Boiler}):

$${H}_{Boiler} [ t ] = {η}_{Boiler} \cdot {NG}_{Boiler} [ t ] \qquad ( 12 )$$

$${CO2}_{Boiler} [ t ] = {β}_{Boiler} \cdot {NG}_{Boiler} [ t ] \qquad ( 13 )$$

Similarly, the electric chiller was modeled with a constant coefficient of performance (COP_{EChiller}) in Eq. (14), where (E_{EChill,in}) is the electricity sent to the chiller:

$${C}_{EChiller} [ t ] = {E}_{EChiller , i n} [ t ] \cdot {COP}_{EChiller} \qquad ( 14 )$$

Exhaust scrubbing was also included as a baseline technology in this example. Oxidation catalysts and selective catalytic reduction (SCR) catalysts were used in aftertreatment scrubbing to remove CO and NOₓ, leaving an exhaust stream clean enough to send to the greenhouse. The model enabled CO₂ demand to be met either through the purchase of pure CO₂ or by operating one of the combustion technologies and treating the exhaust to supply the plant canopy. Due to the high cost of purchasing CO₂ in the U.S., onsite CO₂ production is commonly employed; and therefore, it was incorporated into the baseline scenarios of the example. The exhaust treatment process captures CO₂ while filtering out harmful chemical byproducts that could affect plant growth or human health. The combustion exhaust sent to the treatment process (CO2_{ToTreated}) converted into usable CO₂ (CO2_{Treated}) was represented by Eq. (15) where η_{CO2T} is the percentage of CO₂ in the exhaust that was retained and used in the cleaner exhaust stream exiting the treatment process.

$${CO2}_{Treated} [ t ] = {CO2}_{Onsite} [ t ] \cdot {S}_{AT , CO 2} \qquad ( 15 )$$

CHP Performance: Performance of CHP units was not linear and depends on other factors such as input air temperature (Tₐ) and load percentage (LP). Part-load performance can be modeled using three-dimensional piecewise linear approximation (PLA) with Tₐ and LP as independent variables. The dependent variable of the PLA was a composite output comprised of three outputs: fuel usage, electricity generation, and thermal production. A PLA model for CHP performance was developed for this research and is included in the model. Due to computational complexity, this performance model was not used for this example.

Alternatively, a constant performance model can be used instead of the PLA part-load model. The constant efficiency model was much less computationally expensive but generally provided a slightly less accurate representation of real engine performance. Using this CHP model, a constant thermal efficiency (η_{CHP,T}) and electrical efficiency (η_{CHP,E}) were used to calculate thermal (H_{CHP}) and electrical outputs (E_{CHP}) in Eqs. (16) and (17).

$${H}_{CHP} [ t ] = {η}_{CHP , T} [ t ] \cdot {NG}_{CHP} [ t ] \qquad ( 16 )$$

$${E}_{CHP} [ t ] = {η}_{CHP , E} [ t ] \cdot {NG}_{CHP} [ t ] \qquad ( 17 )$$

CHP units were limited by Eqs. (18) and (19) to only operate above a minimum load percentage LP_{CHP,min} using a binary switch variable that constrained the CHP to run in one of two possible states: ON (Switch_{CHP}=1) where the CHP can run anywhere in the range of 50-100%, or OFF (Switch_{CHP}=0) where the CHP runs at 0%.

$${NG}_{CHP} [ t ] \geq {LP}_{CHP , m i n} \cdot {NG}_{CHP , m ax} \cdot {Switch}_{CHP} [ t ] \qquad ( 18 )$$

$${NG}_{CHP} [ t ] \leq {NG}_{CHP , m ax} \cdot {Switch}_{CHP} [ t ] \qquad ( 19 )$$

The CO₂ output of CHP units, regardless of performance model, was represented by a linear function of fuel consumption, proportional to the carbon conversion factor (β_{CHP}).

$${CO2}_{CHP} [ t ] = {β}_{CHP} \cdot {NG}_{CHP} [ t ] \qquad ( 20 )$$

Auxiliary Technologies: Additional technologies such as absorption cooling and energy storage systems can be synergistically implemented with CUP to increase overall effectiveness. Absorption cooling was also modeled with a constant coefficient of performance (COP_{Abs}). Cooling provided (Cool_{Abs}) was a function of the amount of heat sent to the chiller (H_{Abs,in}) and was converted into units of kWhc using the conversion factor (γ) of 293.07 kWh/1 MMBtu.

$${Cool}_{A b s} [ t ] = {COP}_{A b s} \cdot {H}_{A b s , i n} [ t ] \cdot γ \qquad ( 21 )$$

The storage components included heating thermal energy storage system (TESSH), cooling energy thermal energy storage system (TESSC), battery energy storage system (BESS), and CO₂ storage system (CO2S). The state of charge (SOC) represented how full a storage system is. If available (A=1), the SOC must be between 0 (empty/depleted) and 1(fully charged). Since battery capacity and efficiency is affected by prolonged periods of either overcharging or deep discharging, adjustable minimum and maximum SOC limits were put in place in Eq. (26). The amount of energy in each storage system is dependent on the SOC of the previous time step and how much was charged and discharged while accounting for standing efficiency (η_{stand}), charging efficiency (η_{charge}), and discharging efficiency (η_{discharge}) for a specific storage technology. This means that the physical representation of the SOC values calculated by Eqs. (22)-(26) was the storage level at the end of the time step to which it was assigned.

$${SOC}_{TESSH} [ t ] = ( {SOC}_{TESSH} [ t - 1 ] \cdot {η}_{TESSH , stand} ) + \frac{{H}_{TESSH , in} [ t ] \cdot {η}_{TESSH , charge}}{{H}_{TESSH , capacity}} - \frac{{H}_{T E SSH , out} [ t ]}{{η}_{T E SSH , discharge} \cdot {H}_{T E SSH , cap}} \qquad ( 22 )$$

$${SOC}_{TESSC} [ t ] = ( {SOC}_{TESSC} [ t - 1 ] \cdot {η}_{TESSC , stand} ) + \frac{{C}_{TESSC , in} [ t ] \cdot {η}_{TESSC , charge}}{{C}_{TESSC , capacity}} - \frac{{C}_{T E SSC , out} [ t ]}{{η}_{TESSC , discharge} \cdot {C}_{TESSC , cap}} \qquad ( 23 )$$

$${SOC}_{C O 2 S} [ t ] = ( {SOC}_{CO 2 S} [ t - 1 ] \cdot {η}_{CO 2 S , stand} ) + \frac{CO {2}_{CO2S , in} [ t ] \cdot {η}_{CO 2 S , charge}}{CO {2}_{CO 2 S , capacity}} - \frac{CO {2}_{CO 2 S , out} [ t ]}{{η}_{CO 2 S , discharge} \cdot CO {2}_{CO 2 s , cap}} \qquad ( 24 )$$

$${SOC}_{BESS} [ t ] = ( {SOC}_{BESS} [ t - 1 ] \cdot {η}_{BESS , stand} ) + \frac{{E}_{BESS , in} [ t ] \cdot {η}_{BESS , charge}}{{E}_{BESS , capacity}} - \frac{{E}_{B ESS , out} [ t ]}{{η}_{B ESS , discharge} \cdot {E}_{B ESS , cap}} \qquad ( 25 )$$

$${SOC}_{BESS , min} \leq {SOC}_{B E S S} [ t ] \leq {SOC}_{BESS , max} \qquad ( 26 )$$

Post-combustion Carbon Capture (PCC) was modeled as part of Carbon Capture Utilization and Storage (CCUS) system. The system was modeled as on or off by a binary switch variable. Carbon capture can be done in several ways, but all of them require a significant amount of energy. Typically, for post-combustion applications, the energy input is taken from the power-generating device to which the capture system is attached. For this reason, a “parasitic load” or “derating factor” is commonly linked to PCC devices. Since the energy required for the carbon capture process could potentially come from other sources, this model used a heat rate (HR_{CC}) and electrical rate (ER_{CC}) that represent the amount of heat and electricity respectively needed to output one lb. of CO₂. This energy can come from any of the energy supplying devices present in a given simulation.

$$CO {2}_{CC , out} [ t ] = CO {2}_{C C , i n} [ t ] \cdot {η}_{C C} \qquad ( 27 )$$

$${H}_{C C} [ t ] = CO {2}_{C C , out} [ t ] \cdot {HR}_{C C} \qquad ( 28 )$$

$${E}_{C C} [ t ] = CO {2}_{C C , out} [ t ] \cdot {ER}_{C C} \qquad ( 29 )$$

Energy Flow Constraints: To ensure energy conservation, the correct direction of energy flow, and to allow for expansion of the model, a set of energy constraints were built to represent different sections of a physical system. Each element of the constraints represented an energy stream that may only receive energy from a specific combination of sources and lead to a specific combination of possible discharge points. Some energy streams that have passed through decision points and continued downstream (toward the end-use/CEA) were labeled as “continue” elements. FIGS. 3 and 4 provide diagrams to illustrate the energy pathways represented by the model.

Heat was generated onsite by the boiler or the CHP units. This heat had the option to be sent to the thermal storage tank (H_{TESSH,in}) or the bypass storage. The heat that was not sent to charge the storage tank (H_{Continue,i}), as well as heat that has been discharged from storage (H_{TESSH,out}), could be sent to the absorption chiller (H_{Abs,in}) or carried on downstream (H_{Continue,2}). Finally, this thermal energy could be delivered to the CEA (H_{CEA,Demand}) facility or exported/dumped (H_{Dump}). Eqs. (30)-(35) model this flow of thermal energy for heating.

$${H}_{Boiler} [ t ] + {H}_{CHP} [ t ] - {H}_{TESSH , i n} [ t ] = {H}_{Continue 1} [ t ] \qquad ( 30 )$$

$${H}_{Continue 1} [ t ] \geq 0 \qquad ( 31 )$$

$${H}_{Continue 1} [ t ] + {H}_{TESSH , out} [ t ] - {H}_{A b s , i n} [ t ] = {H}_{Continue 2} [ t ] \qquad ( 32 )$$

$${H}_{Continue 2} [ t ] \geq 0 \qquad ( 33 )$$

$${H}_{Continue 2} [ t ] - {H}_{CEA , Demand} [ t ] = {H}_{Export} [ t ] \qquad ( 34 )$$

$${H}_{Dump} [ t ] \geq 0 \qquad ( 35 )$$

Electricity can be generated onsite by the CHP or purchased from the grid. The energy from those two sources can be delivered to the battery (E_{Bess,in}) or continue on. This stream of energy, combined with any electricity from the battery can either be delivered to the electric chiller, directly to the CEA to meet other electric loads (lights, fans, pumps, etc.), or exported/dumped (E_{Export}). Eqs. (36)-(39) model this process.

$${E}_{CHP} [ t ] + {E}_{Grid , buy} [ t ] - {E}_{BESS , in} [ t ] = {E}_{Continue 1} [ t ] \qquad ( 36 )$$

$${E}_{Continue 1} [ t ] \geq 0 \qquad ( 37 )$$

$${E}_{Export} [ t ] = {E}_{Continue 1} [ t ] + {E}_{BESS , out} [ t ] - {E}_{Chiller , in} [ t ] - {E}_{CEA , Demand} [ t ] \qquad ( 38 )$$

$${E}_{Export} [ t ] \geq 0 \qquad ( 39 )$$

Cooling power was generated either by using the heat sent to the absorption chiller or electricity sent to the electric chiller. Both of the variables were included in the energy flow constraints above. The cooling capability from the chillers could either be sent to the cold-water storage tank or proceed downstream. This energy that bypassed storage combined with energy delivered from the TESSC to meet the CEA cooling demand. This process was modeled by Eqs. (40)-(42).

$${C}_{EChiller} [ t ] + {C}_{A b s} [ t ] - {C}_{TESSC , in} [ t ] = {C}_{Continue 1} [ t ] \qquad ( 40 )$$

$${C}_{Continue 1} [ t ] \geq 0 \qquad ( 41 )$$

$${C}_{Continue 1} [ t ] + {C}_{TESSC , out} [ t ] = {C}_{CEA , demand} [ t ] \qquad ( 42 )$$

Carbon dioxide could be generated onsite by the boiler or CHP system. At this stage, it is part of the exhaust stream, which was not yet suitable to be injected into the plant growth area. This untreated exhaust can be sent to the treatment process (CO2_{ToTreat}), provided the treatment process is activated (CO2_{Treat,Switch}[t]=1). The amount of CO₂ exiting the process (CO2_{Treated}) was governed by Eq. (15).

Once treated, the exhaust (primarily consisting of air, water vapor, and CO₂) can be sent to the greenhouse or released into the environment. This scrubbing aftertreatment is common for combustion devices to comply with environmental regulations and to avoid damaging the plants with CO emissions. A developing technology that is much less common is carbon capture utilization and storage (CCUS). Whereas scrubbers allow CO₂ to continue as part of the exhaust stream, carbon capture units extract the carbon dioxide and create a pure, storable stream of CO₂.

The model incorporated carbon capture, and the resulting CO₂ could be routed to the CO₂ storage (CO2_{cO2s,in}) or delivered directly to the grow room. Aftertreatment CO₂ in exhaust (CO2_{Treated,Continue}), CO₂ directly from the carbon capture, CO₂ from storage (CO2_{CO2S,out}), and purchased pure CO₂ (CO2_{Mkt}) combined to meet the CEA demand. Meanwhile, any CO₂ that bypassed the treatment process and the CO₂ unsuccessfully captured during the capture process were quantified as CO2_{Untreated}. The flow of CO₂ is modeled with Eqs. (43)-(51).

$$CO {2}_{O nsite} [ t ] = CO {2}_{Boiler} [ t ] + CO {2}_{CHP} [ t ] \qquad ( 43 )$$

$$CO {2}_{T reated} [ t ] = CO {2}_{Onsite} [ t ] \cdot {S}_{A T , CO 2} \qquad ( 44 )$$

$$CO {2}_{Continue , 1} [ t ] = CO {2}_{T reated} [ t ] - CO {2}_{C C , i n} [ t ] \qquad ( 45 )$$

$$CO {2}_{CC , in} [ t ] \leq {Switch}_{C C} [ t ] + CO {2}_{CC , cap} \qquad ( 46 )$$

$$CO {2}_{CC , in} [ t ] \leq CO {2}_{T reated} [ t ] \qquad ( 47 )$$

$$CO {2}_{C C , out} [ t ] = CO {2}_{C C , i n} [ t ] \cdot {η}_{C C} \qquad ( 48 )$$

$$CO {2}_{Continue , 2} [ t ] = CO {2}_{C C U , out} [ t ] - CO {2}_{CO 2 s , i n} [ t ] \qquad ( 49 )$$

$$CO {2}_{Continue , 1} [ t ] + CO {2}_{Continue 2} [ t ] + CO {2}_{CO 2 S , out} [ t ] + CO {2}_{Mkt} [ t ] \geq CO {2}_{CEA , Demand} [ t ] \qquad ( 50 )$$

$$CO {2}_{E m issions} [ t ] = CO {2}_{O nsite} [ t ] + CO {2}_{G r i d} [ t ] + CO {2}_{Mkt , Emissions} \qquad ( 51 )$$

### Methods—Optimization

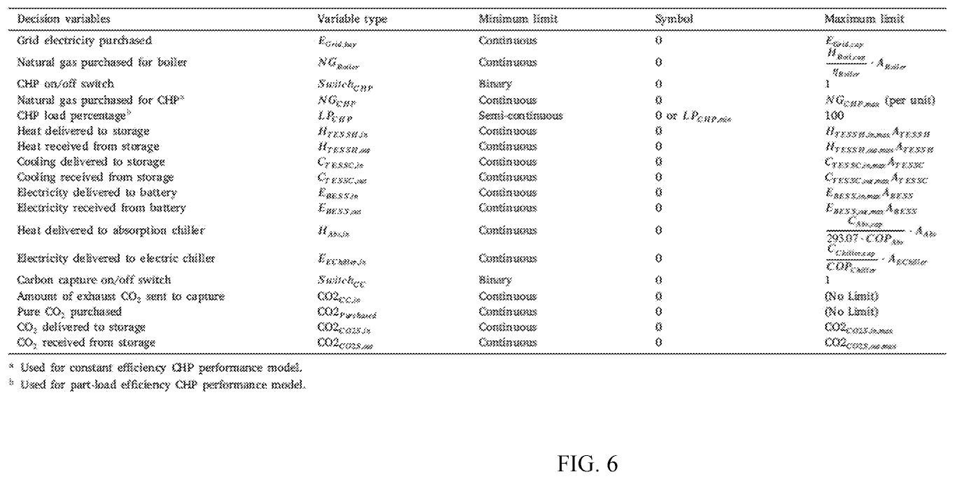

Once the model was virtually assembled, energy dispatch decisions on the basis of cost and emissions could be used to optimize for specific results. A multi-objective objective mixed-integer linear program (MILP) was developed to optimize based on cost and emissions. Decision Variables: A defined set of variables, known as decision variables, were designated for optimization. These decision variables, listed in FIG. 6, were the parameters that the solver can adjust to identify the optimal solution. All other elements in the model were exogenous variables, parameters, or derived expressions; their values were pre-defined or calculated based on the decision variables, following the model's equations and constraints.

Objective Functions: The objective function was comprised of two main parts: costs and emissions. The optimizer aimed to minimize these metrics over a given time period by adjusting the energy dispatch decision variables, based on a predefined set of demands and available technologies within the scenario.

The costs of purchasing natural gas, electricity, and pure CO₂ were included as positive costs that account for the time-varying market prices of gas (P_{NG}), electricity (P_{E,Buy}), and CO₂ (P_{CO2}). Considering the potential to sell electricity back to the grid or directly to other consumers in a microgrid setting, the total net cost calculation also included electricity sales as a negative cost. The revenue from electricity exports factored in a separate price at which the electricity can be sold (P_{E,Buy}), which was determined by the market price factor (MPF)—the fraction of the price to buy energy at which energy can be sold.

$${Cost}_{N G} [ t ] = {P}_{NG} [ t ] \cdot ( {NG}_{B o i l e r} [ t ] + {NG}_{C H P} [ t ] ) \qquad ( 2 )$$

$${Cost}_{E} [ t ] = {P}_{E , Buy} [ t ] \cdot {E}_{Grid , buy} [ t ] \qquad ( 3 )$$

$${Cost}_{C O 2} [ t ] = {P}_{CO 2} [ t ] \cdot CO {2}_{Buy} [ t ] \qquad ( 4 )$$

$${P}_{E , S e l l} [ t ] = {P}_{E B u y} [ t ] \cdot MPF \qquad ( 5 )$$

$$Sales [ t ] = {P}_{E , Sell} [ t ] \cdot {E}_{Export} [ t ] \qquad ( 6 )$$

$${Cost}_{net} [ t ] = {Cost}_{NG} [ t ] + {Cost}_{E} [ t ] + {Cost}_{CO 2} [ t ] - Sales [ t ] \qquad ( 7 )$$

Emissions from onsite natural gas combustion, grid electricity generation, and direct CO₂ production were accounted for in the net emissions calculation. The total emissions included all CO₂ produced onsite, regardless of whether it had been treated or captured. Emissions rates related to grid energy were calculated using a grid emissions rate (GER_{CO2e}).

$${Emissions}_{O nsite} [ t ] = CO {2}_{O nsite} [ t ] \qquad ( 8 )$$

$${Emissions}_{G r i d} [ t ] = {E}_{Grid , buy} [ t ] \cdot {GER}_{CO 2 e} \qquad ( 9 )$$

$${Emissions}_{CO 2 Buy} [ t ] = \frac{CO {2}_{B u y} [ t ]}{{η}_{CO 2 Attainment}} \qquad ( 10 )$$

$${Emissions}_{Total} [ t ] = {Emissions}_{O nsite} [ t ] + CO {2}_{G r i d} [ t ] + {Emissions}_{CO 2 Buy} [ t ] \qquad ( 11 )$$

The objective function, as shown in Eq. (1), minimized the net costs and total emissions from tᵢ to t_{f}. Weights were assigned to each metric—w_{cost} for total costs and Wₑₘᵢₛₛᵢₒₙₛ for total emissions—to allow flexibility in emphasizing economic versus environmental objectives. The sum of net costs and total emissions was calculated across all time steps, reflecting the integrated impact of energy dispatch decisions on costs and emissions throughout the simulation period. Adjusting the weights enabled multi-objective optimization, allowing users to tailor the outcome to specific priorities.

$$min {\sum }_{t = {t}_{i}}^{{t}_{f}} ( {w}_{cost} \cdot {Cost}_{net} [ t ] + {w}_{emissions} \cdot {Emissions}_{total} [ t ] ) \qquad ( 1 )$$

Simulation Details and Rolling Horizon: The optimization program was designed to simulate optimal annual operations for a CEA energy system and assist CEA operators in optimizing real-time performance. A rolling horizon simulation technique enhanced both of these goals. For annual simulations, the vast number of variables and time steps generated an extremely large and complex MILP, which was computationally demanding. By dividing the year into smaller intervals, the rolling horizon method allowed for a manageable problem size while preserving interdependencies between time steps. In practice, energy planning can cover a defined timeframe, allowing operators to implement a forward energy procurement strategy that utilizes mechanisms such as day-ahead pricing. As system, market, and weather conditions diverge from initial forecasts or new information arises, the optimal operational strategy shifts. Using a rolling horizon approach, the system could continually update and recalibrate in response to current conditions and forecasted developments, enhancing the accuracy and responsiveness of the simulation. In the context of annual simulations, the rolling horizon technique was implemented by first initializing the optimization program and defining a specific simulation interval. The program optimized the energy system's operations within this interval, taking into account various constraints and objectives. After completing the optimization, a subset of the results was saved, particularly focusing on the state variables at the final time step of that interval. These final states serve as the initial conditions for the subsequent iteration. The process was then repeated, with the simulation interval advancing forward, until the final time step of the overall annual simulation was reached.

### Case Study

To illustrate the optimization control framework, a case study was conducted using a specific set of CEA energy demands and market energy prices as inputs. The study simulated several scenarios to evaluate the effectiveness of various combinations of CHP, absorption cooling, TESSs for both heating and cooling, and CCUS. Additional simulations examined the effect of electricity market participation at different market price factors on optimal energy procurement and dispatch strategies.

Input Data: This section details the energy demand and energy price datasets used as inputs for the case study. The selected datasets represented a specific location and operational context, with the demand profile based on typical energy usage patterns and the pricing profile informed by market data. The input data was pre-determined and fixed, without considering the potential for demand shifting. In real-world applications, historical data can inform system design, while real-time operational strategies can leverage weather predictions, models, and forward market data to adapt dynamically.

Greenhouse Energy Demand: Input data to the energy dispatch optimization model will include hourly time-step demand profiles for heating, cooling, non-cooling electricity, and CO₂ for one full year (“8760 demand profiles”). These demand profiles for a greenhouse will vary significantly based on location, crop, envelope design, and grower preferences among other details. For the case study, an 8760 profile was obtained through SIOM: a model built and simulated at the TNO, a Dutch public research and technology organization. The simulation was specifically for a 25-acre tomato greenhouse in State College, Pennsylvania. A 2024 U.S. Department of Agriculture 2024 report shows that by weight, tomatoes account for about half of CEA food crop production in the country. The 2022 Agriculture Census reported that there were 8578 farms growing tomatoes under protection on 1570 acres of land. The 25-acre greenhouse was meant to represent an industrial-scale commercial greenhouse.

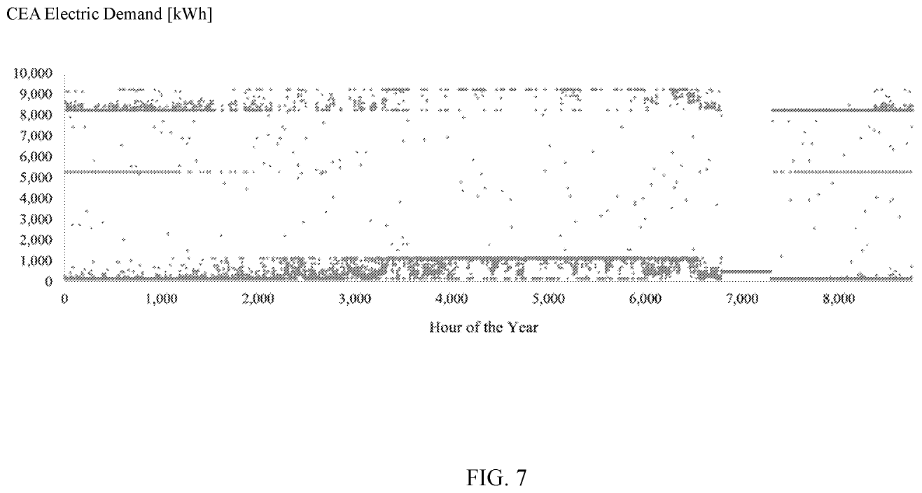

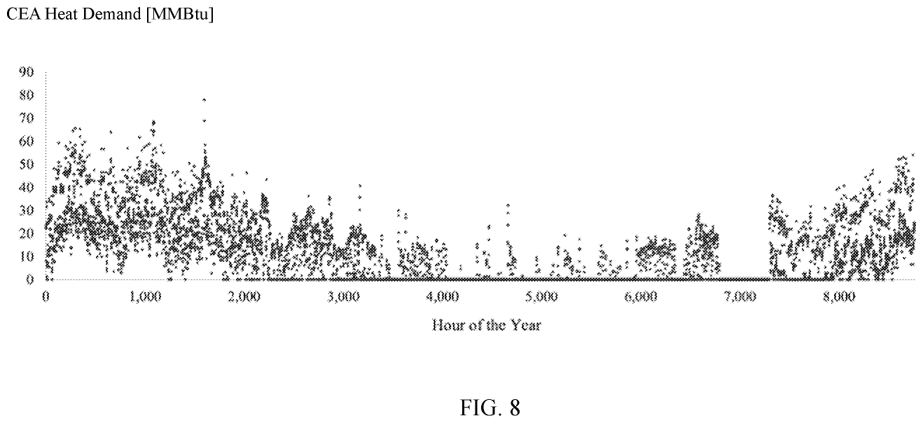

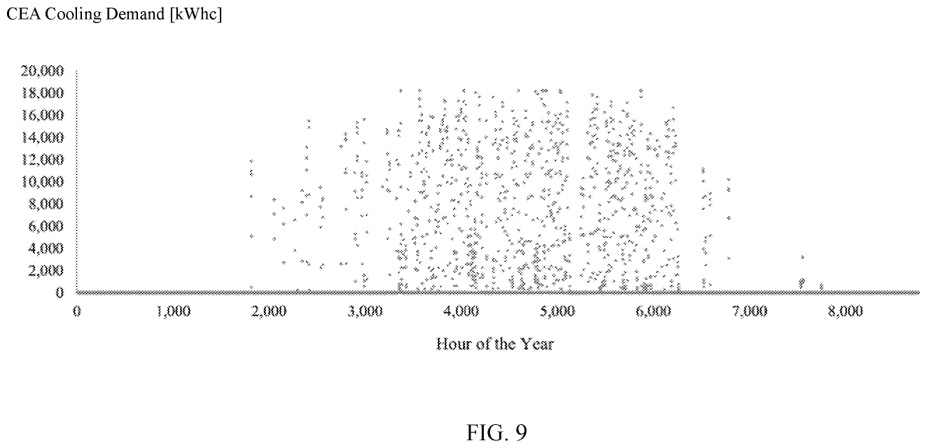

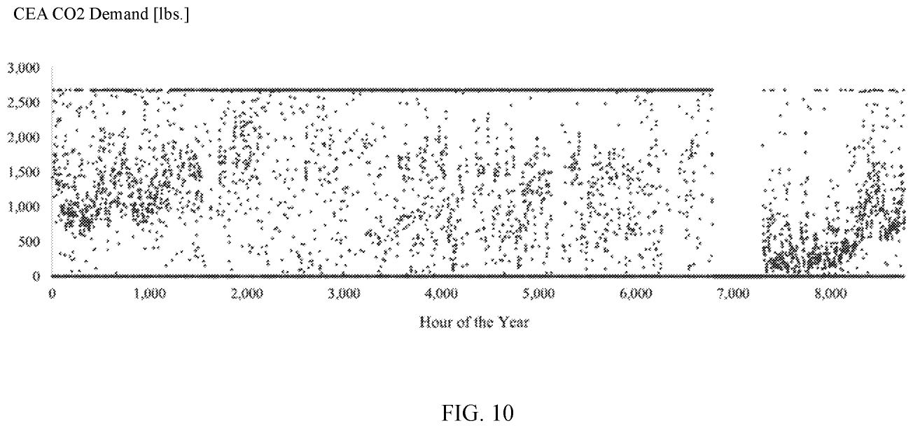

Demand data used as inputs included heating, cooling, electricity, and CO₂ (weight). It is important to note that the electric demand originally accounted for cooling and dehumidification. This also means that the electric demand was able to be shifted by the optimizer when absorption cooling was included, as the absorption chiller decreased the load on the electric chiller. Key statistics of the demand profiles are summarized in Table 1. The demand profiles are shown in FIGS. 7-10.

TABLE 1
Summary of Energy and CO₂ Usage

| | Total | Max | Min | Hours >0 |
|---|---|---|---|---|
| Electricity | 25,083,833 | 13,243.62 | 136.62 | 8760 |
| [kWh] | | | | |
| Heating Energy | 93,221 | 77.82 | 0 | 4543 |
| [MMBtu] | | | | |
| Cooling Energy | 8,827,855 | 18,216.00 | 0 | 1135 |
| [kWhc] | | | | |
| CO₂ [lbs.] | 9,209,464 | 2677.29 | 0 | 8223 |

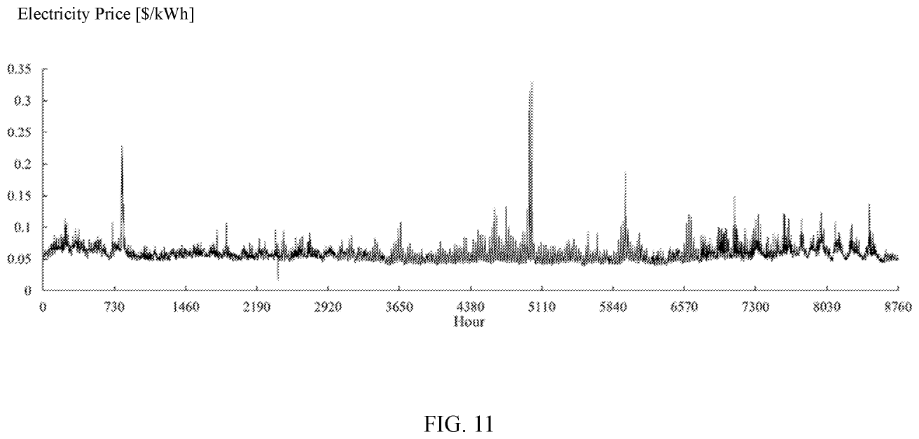

Energy Pricing and Emissions Accounting: The case study also incorporated utility prices as key inputs, including the cost of natural gas, electricity, and pure CO₂. Energy markets in the United States are highly complex, involving multiple stakeholders that vary based on location and customer choices. Energy can often be procured anywhere from years in advance to real-time transactions. To realistically and consistently model energy costs, the case study used historical data relevant to the proposed greenhouse site. For electricity, the study relied on day-ahead Locational Marginal Prices (LMPs) from the local Regional Transmission Organization (RTO), with an additional constant charge to account for transmission and distribution costs. This approach captured the variability of energy costs through LMPs while ensuring the total cost reflects consumer expenses. For the State College, Pennsylvania site, the RTO is PJM, and the local pricing node is SHINGLET (ID #5021520). Hourly day-ahead energy prices from Jan. 1, 2023, to Dec. 31, 2023, ranged from −0.01373 $/kWh to 0.30058 $/kWh. A constant charge of 0.03006 $/kWh, estimated using Penn State University's utility bills, was added to the PJM price. The electricity prices used in the case study are shown in FIG. 11.

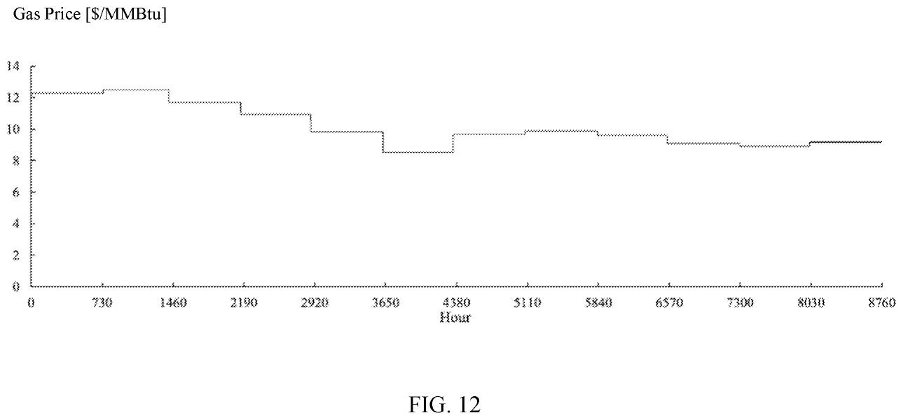

For natural gas prices, the study utilized monthly data from the EIA's API dashboard. Historical industrial gas prices for the relevant state were provided in $/MCF and applied uniformly across each hour of the corresponding month. For months with missing data, prices were interpolated using the average of the preceding and following months. The gas prices used in the case study are shown in FIG. 12.

The price of CO₂ was modeled as a constant value derived from publicly available prices in the United States. For this case study, the CO₂ price was set at 0.30 $/lb.

The emissions associated with energy procurement and generation were accounted for in the model as well. The grid CO₂ emission rate (GER) was calculated using the EPA's eGRID Power Profiler and eGRID Data Explorer, based on 2022 eGRID data. This provided the average CO₂-equivalent (CO2e) emissions per MWh generated in a specific grid region. For the case study, West Penn Power was the selected supplier, corresponding to the 16803 area code. Therefore, the eGRID emission rate for the RFCW region was used, which was 1005.9 lbs. CO2e/MWh. Emission rates for the combustion technologies (β_{Boiler} and β_{CHP}) were derived from the EIA's carbon dioxide emissions coefficient for natural gas. Slightly different coefficients were assigned to these technologies to allow the optimizer to select between them.

Technology Design Details and Optimization Weights: Technology performance and sizing parameters used in this case study are summarized in FIG. 5. The capacities of baseline technologies were determined based on maximum observed demand values. For other technologies, capacities were assigned reasonable estimates appropriate for the system size and demand profile. Performance characteristics, such as efficiencies and coefficients of performance (COPs), used in this case study were selected based on typical industry standards. For this case study, the constant efficiency performance model of the CHP units was implemented.

Each scenario in the case study was solely optimizing energy dispatch to minimize procurement costs. This means that the multi-objective function of the model was not demonstrated in this case study as wₑₘᵢₛₛᵢₒₙₛ was set to 0 while w_{cost} was set to 1 for all scenarios.

Simulation Details: Each simulation was run using a rolling horizon technique by optimizing over a 72-h period and saving the first 24 h as results. The 24^{th} hour was then used as initial conditions for the next 72-h optimization. To produce annual results, 363 optimization periods were solved with the final period saving all 72 h to complete the 8760-h simulation. The model was developed using the domain-specific modeling language JuMP within the Julia programming environment. The MILP was solved using the HiGHS optimizer to generate the case study results.

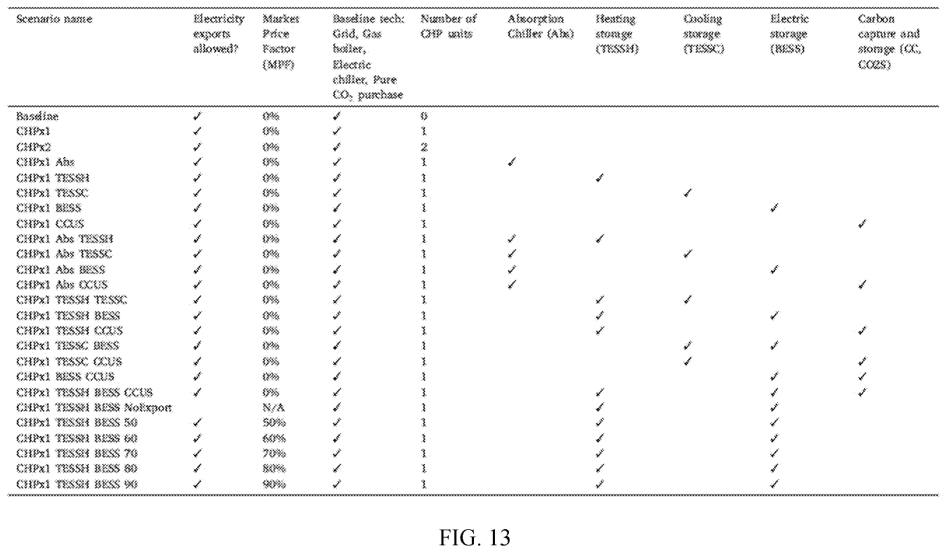

FIG. 13 summarizes the key characteristics of 25 simulations, including technology configurations, grid connectivity, electricity export conditions, market price factors, and the number of CUP units. Every scenario included the boiler, electric chiller, grid connection, and the option to purchase pure CO₂. One scenario evaluated the system with a single CUP device, and another considered a configuration with two CUP devices. Subsequently, various auxiliary technology combinations were analyzed in a scenario that allows but does not incentivize electricity exports. Each auxiliary technology was tested individually with the CUP, as well as in combinations of two auxiliary technologies paired with the CUP. Additionally, two combinations involving three auxiliary technologies were analyzed. The pairing of thermal storage and electrical storage was further examined in six additional scenarios, including one where electricity exports were prohibited, to assess the impact of energy trading and market price factors on operational outcomes.

### Results

The results from each scenario have been generated and analyzed across multiple time scales, including annual, daily, and hourly intervals. This multi-scale approach provided a comprehensive understanding of system performance, capturing both long-term trends and short-term operational dynamics. By examining results at these levels, we explored the effectiveness of different technologies under varying circumstances, including their interactions with energy procurement strategies and demand patterns. The analysis focused on how these technologies and circumstances impact cost and emissions, offering valuable insights for optimizing system design and operation across diverse scenarios.

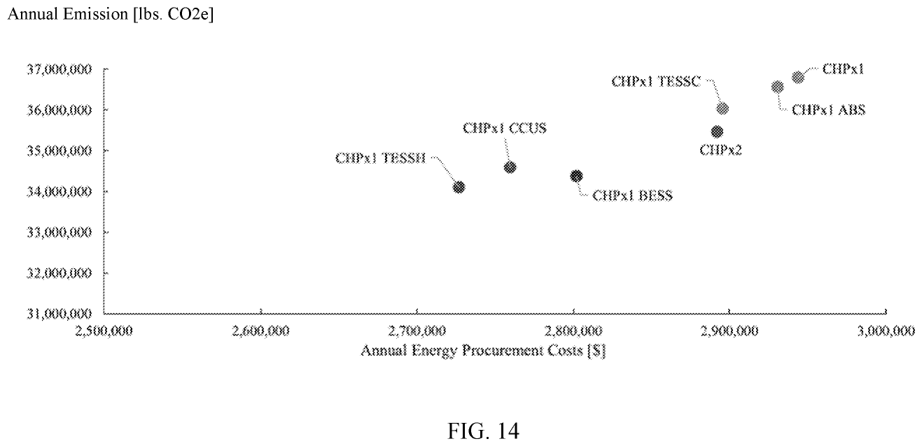

Annual Operation Outcomes for Different Technology Combinations: Apart from the Baseline simulation and the “CHPx2” scenario, all other simulations featured a single CUP unit. The analysis of auxiliary technologies began by assessing the impact of adding each one individually to the system alongside the CUP and baseline technologies. The annual costs and emissions for “CHPx1”, “CHPx2”, and all scenarios with one auxiliary technology are presented in FIG. 14. The scenario incorporating thermal storage for heating (“CHPx1 TESSH”) achieved the best performance in both cost and emissions. Compared to the “CHPx1” scenario, procurement costs with TESSH were reduced by $217,019, or 7.37%, while emissions decreased by 2,693,541 lbs. CO2e, or 7.32%. Looking further into the details of the results from “CHPx1 TESSH”, the thermal storage was able to contribute to efficiency improvements in several areas compared to the “CHPx1” scenario. Less gas was used by the boiler, less gas was used by the CHP, and less electricity was purchased from the grid. One of the main reasons for this is that the CHP was more often able to produce electricity without wasting heat. Heat dumped/exported decreased by system was decreased by 17,856 MMBtu, or 46.43%, once TESSH was introduced.

Notably, many of the cost savings offered by these technologies were accompanied by corresponding reductions in emissions, meaning technologies that performed better in costs also performed better in emissions. The only example that did not follow this trend was with the scenario with the CCUS, which produced lower costs but higher emissions than the BESS. This is because the CCUS system allowed significantly less CHP and boiler usage, as they were decoupled from the CO₂ demand. However, the “CHPx1 CCUS” scenario also saw 25.77% more grid electricity purchased than the “CHPx1 BESS” scenario. In terms of emissions, the increased grid usage along with the carbon intensity of the local grid outweighed the decrease in gas usage.

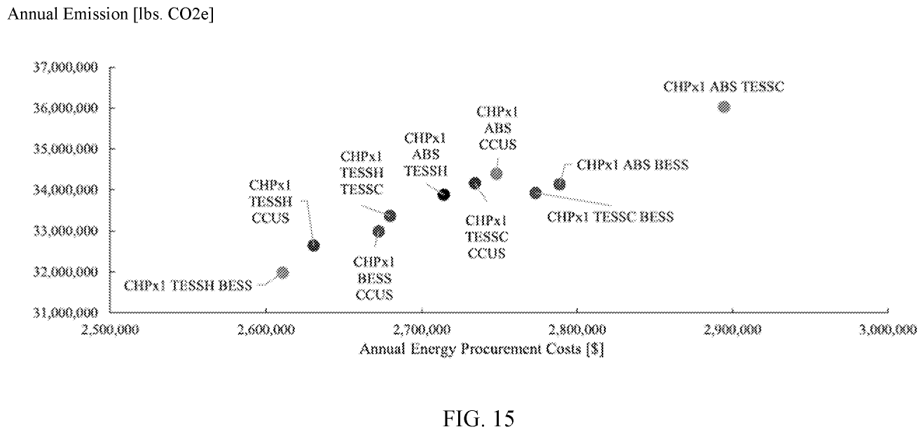

To further evaluate the role of auxiliary technologies in enhancing efficiency, simulations were conducted for combinations of two auxiliary technologies. FIG. 15 presents the annual total costs and emissions for the 10 different combinations. These results continue to show a direct relationship between costs and emissions observed in previous analyses, as reductions in costs generally correspond to reductions in emissions. As anticipated, the highest-performing individual technologies, when paired, created the most effective combinations.

Notably, four of the top five scenarios included TESSH, with the TESSH-BESS pairing achieving the lowest costs and emissions. Interestingly, while CCUS was more cost-effective than BESS when analyzed individually, BESS paired more effectively with TESSH than CCUS did. Individually, TESSH and BESS reduced costs by $217,019 and $141,805, respectively, compared to the CHPx1 scenario. When combined, these technologies achieved a total cost reduction of $333,063. This suggests that, while no significant synergistic effect was observed between these technologies in this context, both contribute to cost and emissions reductions when used together.

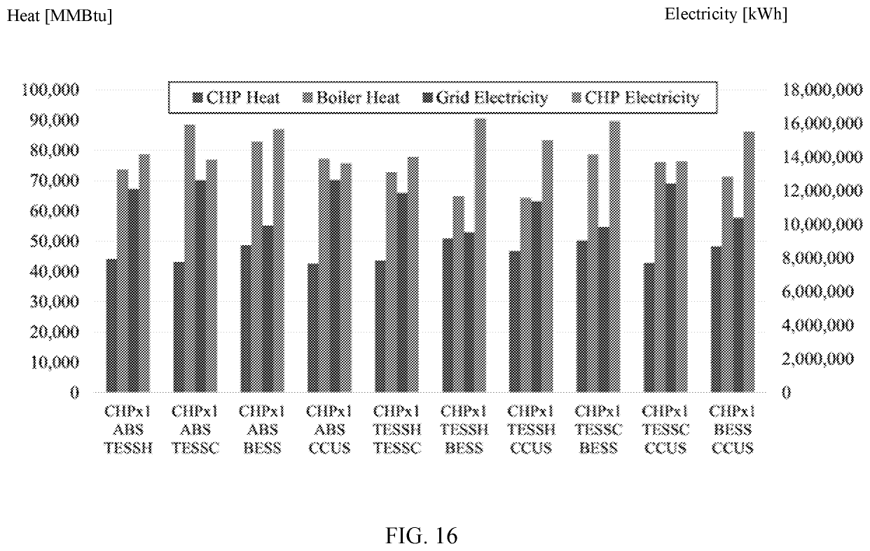

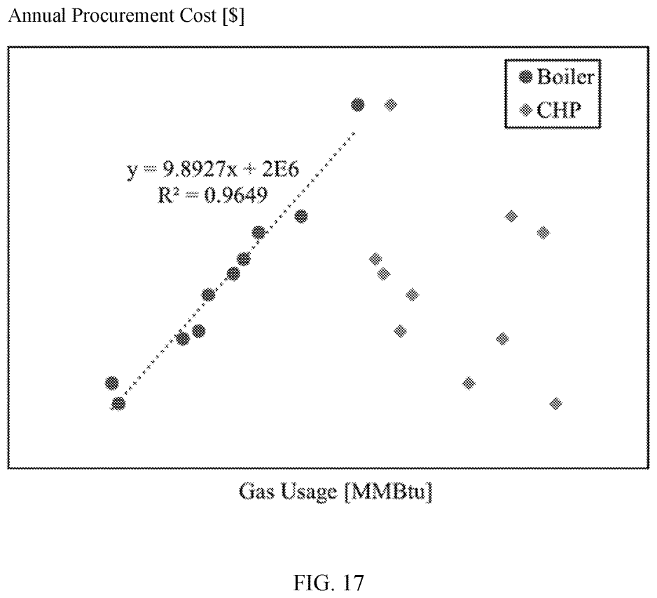

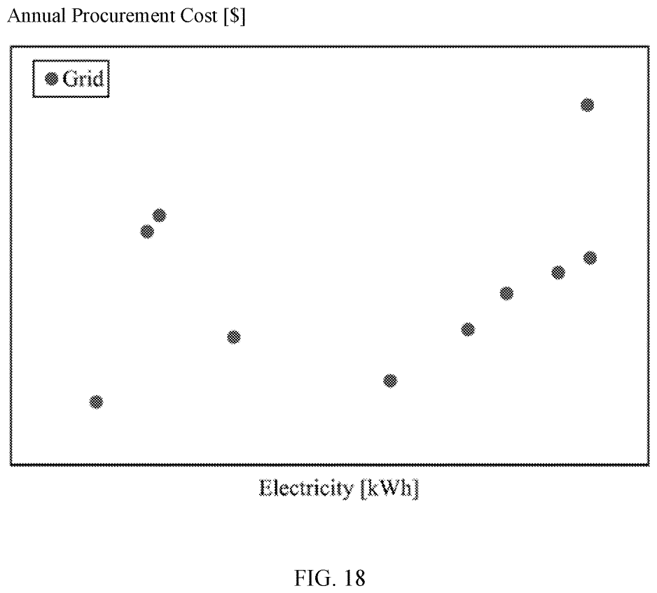

FIG. 16 provides further insight into the operational impacts of these combinations, showing the output of the boiler, grid, and CHP for each simulation involving two auxiliary technologies. The two scenarios with the lowest costs—“CHPx1 TESSH BESS” and “CHPx1 TESSH CCUS”—were also the ones that relied least on the boiler. Furthermore, the “CHPx1 TESSH BESS” scenario purchased the least grid electricity and utilized the CHP unit the most. However, the results suggest that reduced grid usage (see FIG. 18) and increased CUP usage (see FIG. 17) are not consistently strong indicators of lower costs in these scenarios. In contrast, boiler usage exhibited a clear relationship with annual procurement costs. This is highlighted in FIG. 17, which shows that the linear regression between total costs and boiler gas usage has a high R² value of 0.9649, indicating a strong correlation.

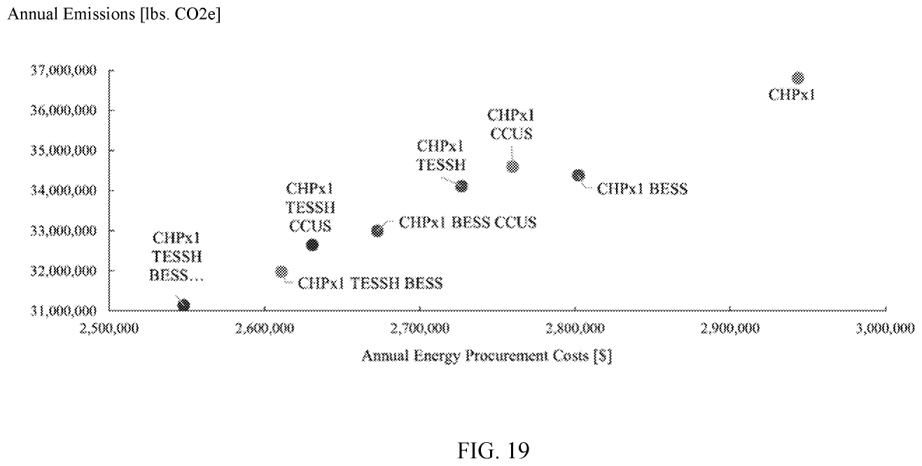

To analyze the potential of combining three auxiliary technologies, a simulation was conducted with the top three performing individual technologies: TESSH, BESS, and CCUS. FIG. 19 highlights how subsequently adding and combining TESSH, BESS, and CCUS with CHP contributes to the operational outcomes. This combination of all three auxiliary technologies results in annual costs of $2,547,728, which is $62,958 (2.4%) lower than the best combination of two auxiliary technologies. Once again, as more auxiliary technologies are added their individual incremental benefits are lessened.

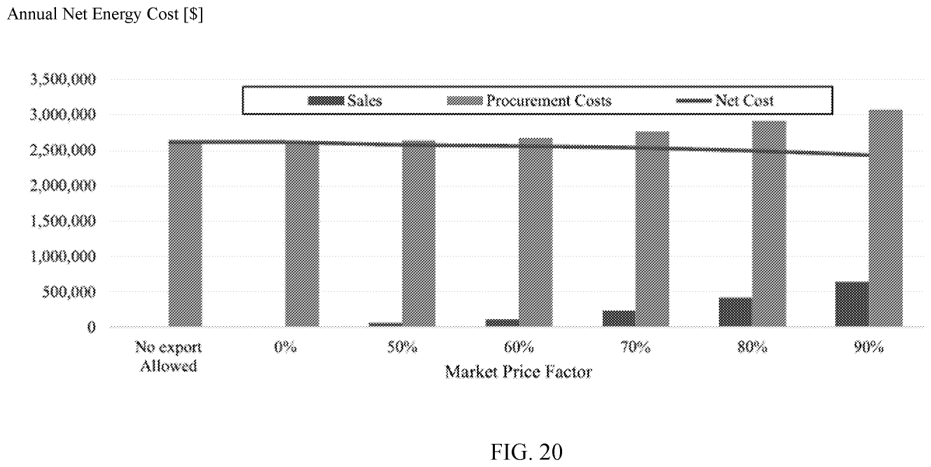

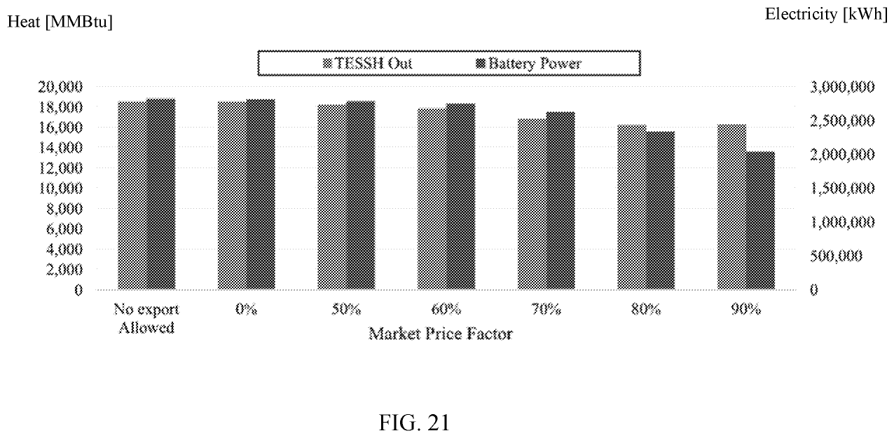

The Effect of Market Participation and Market Price Factors: Next, we examine the effects of participating in the electricity market under varying market price factors. The analysis focuses on the combination of TESSH and BESS, identified as the most effective pairing of two auxiliary technologies. One simulation restricts electricity exports, requiring any surplus electricity produced by the CUP to be stored in the batteries. In contrast, the “CHPx1 TEESH BESS” simulation discussed above allows exports without any associated penalties or rewards. We then explore scenarios where exports are rewarded with market price factor (MPF) varies from 50% to 90% in increments of 10%. The MPF represents the specific fraction of the cost to purchase electricity from the grid at which electricity can be sold. FIGS. 20 and 21 show how costs and energy storage usage changes as market participation is included and as the MPF rises.

There was minimal difference between the scenario with no electricity exports and the scenario where exports were allowed at an MPF of 0%. While higher MPFs led to increased electricity sales, the net cost remained largely unaffected. Even at the highest tested MPF of 90%, the net cost (procurement costs minus sales revenue) improved by only 7% compared to the case with no exports. One contributing factor is the presence of batteries. In many instances, the optimal control strategy directs surplus electricity to the batteries, which supply at least 2 GWh of electricity to the CEA in all scenarios. Regardless of the MPF, electricity exports essentially compete with battery storage for excess electricity, limiting the potential impact of exports.

Another key consideration is the spark spread, the difference between electricity prices and the price of gas used for electricity generation. The spark spread is a common metric used to determine the profitability of gas-based electricity generation. In this case study, the spark spread is relatively low, meaning that electricity generation for the purpose of selling it is not highly profitable at this site. With an average gas price of $10.17/MMBtu and a CHP electric efficiency of 46.40%, the average cost of gas to produce 1 kWh is 7.48 cents. With a 90% MPF, the average price at which electricity can be sold is 5.30 cents per kWh. As a result, electricity sales in these market conditions have a limited impact on the overall financial balance of energy procurement and sales.

Interestingly, the as the MPF rises and electricity sales rise, we see less onsite energy storage. The results show that both the thermal storage and electrical storage output generally decrease as electricity exports increase. One reason for this trend is the increase of CHP production to meet CO₂ production. With no export incentive, the boiler is used more often to generate CO₂. When electricity exports can bring in revenue, however, the CHP is called upon more often. The boiler and the CHP have virtually identical CO₂ output per gas input, but the CUP generates much less useful heat than the boiler. Therefore, there is less excess heat generated during hours with CO₂ demand and no heat demand, so the TESSH is not used as heavily. The BESS is used less often because, once electricity sales are incentivized, it is more cost effective to sell electricity than to store it during some time steps. Storing the electricity comes with some losses during the charging and discharging processes. The optimized results show that immediate sales revenue outweighs the potential of delayed savings in many cases, so the BESS is used less often.

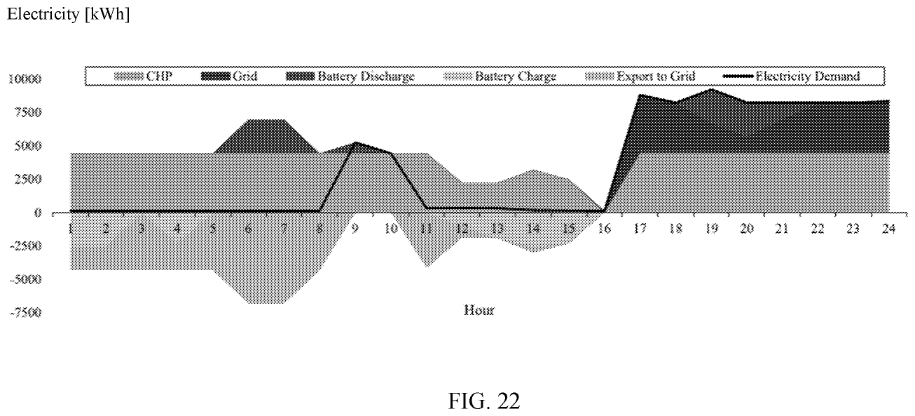

Detailed View of Hourly Energy Balance: To understand more about the detailed optimal operation, hourly electricity, heat, and CO₂ balances for March 20th in the “CHPx1 TESSH BESS 80” scenario are charted in FIGS. 22-24. There was no cooling demand on this day. The detailed results show the CHP being run at full load during hours 1-9, 11, and 17-24 and being run at part-load during hours 10 and 12-15. This results in excess electricity being produced during 13 total hours.

The batteries are charged during seven different hours and discharged during six separate hours. Interestingly, 5 of those hours were to help meet electricity demand, but two of the hours saw the BESS discharge to sell electricity. The reason for this can be found in the dynamic electricity prices. The two highest hourly electricity prices for March 20th were hours 6 and 7, the same hours the BESS is discharged to sell electricity. The optimizer recognized that storing the electricity generated during hours 1,2, and 4 and accepting the efficiency losses connected with the storage process to sell the electricity later was more cost effective than immediately selling electricity at a lower price.

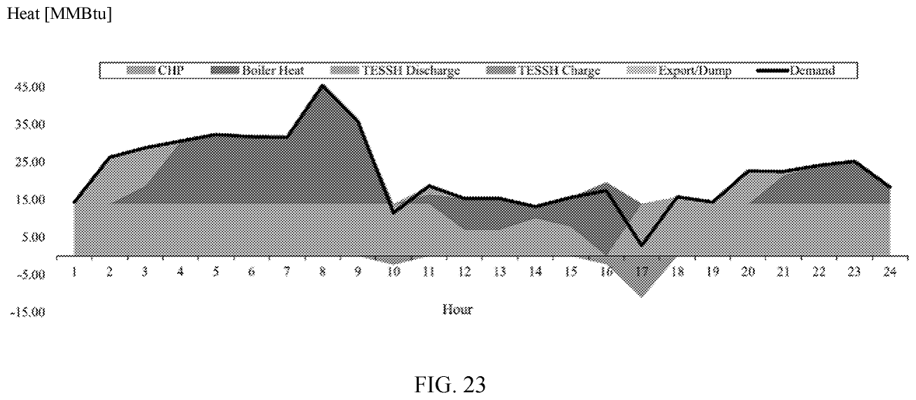

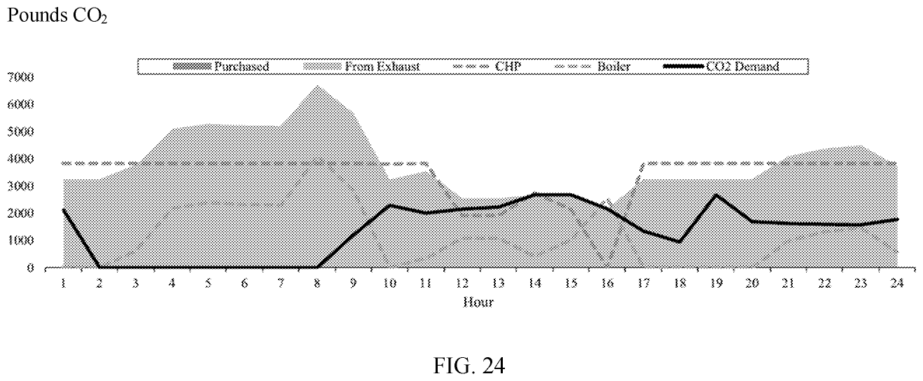

FIG. 23 shows heat generation is perfectly matched to heat demand for most of the day. The TESSH is discharged to help meet demand during eight separate hours of the day, with a total of 36.83 MMBtu supplied to the greenhouse. The system is charged during hours 10, 16, and 17 with a total of 15.79 MMBtu charged into the system. These hours also represent the only hours of the day that excess heat was generated. The CHP was running during hour 10 at a load percentage of 99.6% to meet the electric demand, resulting in the excess thermal production. Similarly, hour 17 shows the CHP running at full capacity to help meet the electricity demand. On the other hand, the reason for excess heat during hours 16 can be found in FIG. 24. The boiler is running to meet the CO₂ demand, which calls for more combustion than the thermal demand.

These dynamic limiting factors underscore the critical role of the optimizer. The continual fluctuations in prices and demand ratios necessitate adaptive solutions to meet operational objectives. Additionally, accounting for demand and pricing in future time steps is shown to significantly contribute to achieving an optimal operating state. The energy dispatch optimization allows CHP operation and energy storage decisions to be sensitive to all demand and price variables, both present and future.

Sensitivity Analysis: To evaluate the dependency on utility prices, a sensitivity analysis was conducted with 38 additional simulations to explore how variations in electricity and gas prices affect total procurement costs and cost savings associated with CHP. This included 12 baseline scenario simulations where electricity and gas prices were independently varied by ±15%, ±10%, and +5%. Additionally, 13 simulations were performed for a system with CHP and TESSH without electricity exports under the same price variations. Another 13 simulations analyzed a scenario with CHP, TESSH, and electricity exports at 80% of the market price.

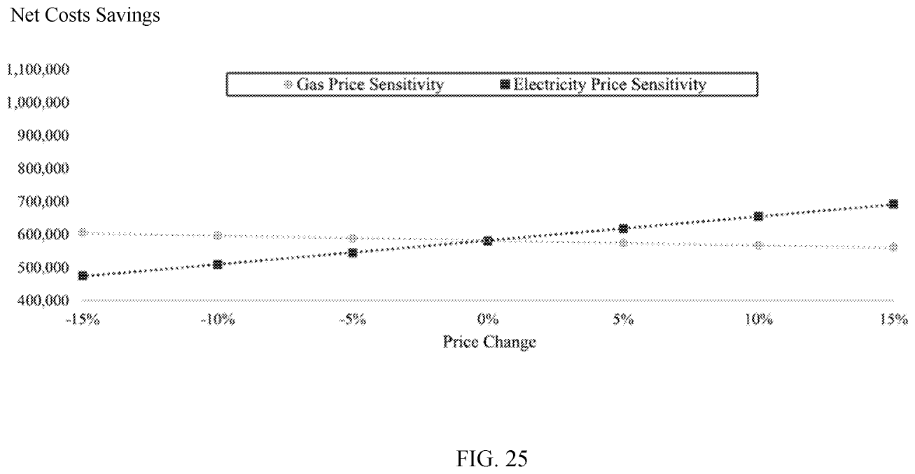

The results revealed a positive linear relationship between utility prices and total procurement costs in scenarios without electricity exports, as shown in FIG. 25. For the baseline scenarios, each 1% change in gas prices caused a $18,125 change in costs, while a 1% change in electricity prices resulted in a $15,511 change. In the “CHP and TESSH (No Export)” scenario, gas prices had a more pronounced impact, with a $19,606 change per 1% variation, compared to $8,257 for electricity prices. When looking at cost savings, or the difference in costs between the baseline scenario and “CUP TESSH (No Export)” scenario under the same price manipulation, there was still a linear dependency on utility prices. FIG. 25 shows the relationship between cost savings related to CHP and utility price variations. At the original utility prices, the system achieved $580,451 in annual cost savings. Increasing electricity prices improved cost savings by $7,255 for each percentage point increase. The relationship between gas prices and cost savings with the CHP TESSH system was negative as each 1% increase in price reduced savings by $1,481. These findings highlight that regions with higher electricity prices make CUP and TESSH systems more economically favorable, while higher gas prices diminish the cost-effectiveness of the system.

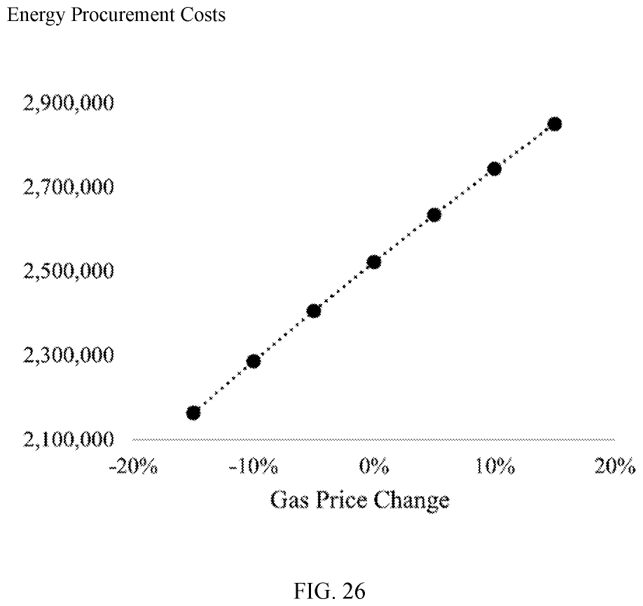

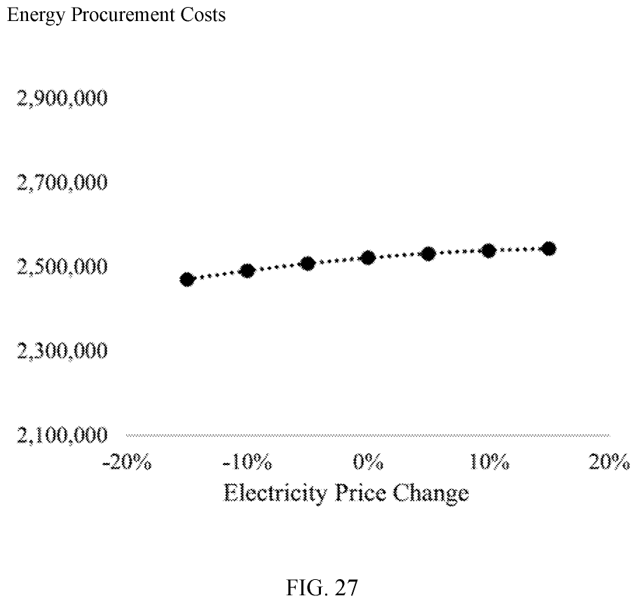

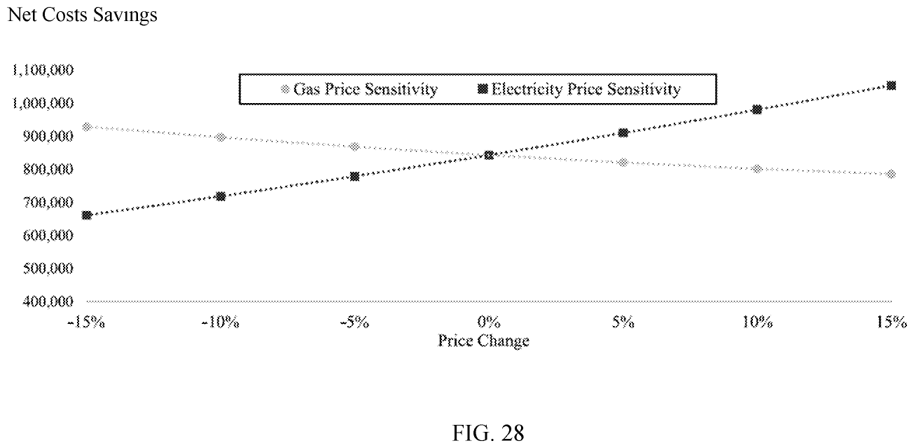

In scenarios allowing electricity exports, the relationship between utility prices and net costs became quadratic as shown in FIGS. 26 and 27 for gas and electricity price variations, respectively. For both gas and electricity prices, the rate of cost increase diminished as prices rose. For example, a 5% increase in electricity prices raised net costs by $9,807, while increasing prices from 5% to 10% resulted in a smaller net cost increase of $7,360. Similarly, the relationship between gas prices and total energy costs was quadratic, though the curve was less pronounced, and the impact of price changes is stronger. Comparing the “CHP, TESSH, Export 80%” scenario with the baseline, FIG. 28 shows that cost savings were highly dependent on electricity prices. At a 15% reduction in electricity prices, the system saved $661,673 annually compared to the baseline. As electricity prices increased, the savings grew significantly, reaching $1,053,401 at a 15% increase in electricity prices. Conversely, rising gas prices reduced the cost savings, but the rate of reduction diminished at higher gas prices. A 15% reduction in gas prices resulted in $928,918 in annual savings, while a 15% increase in gas prices reduced savings to $785,637 annually.

In summary, the sensitivity analysis demonstrated two key trends. First, within individual scenarios, gas prices had a stronger impact on procurement costs, particularly in systems with CHP. Second, when comparing baseline scenarios with those incorporating CHP, electricity prices played a more significant role in determining annual energy net cost savings. Furthermore, the linear relationship observed in scenarios without electricity exports shifted to a quadratic relationship when electricity exports were introduced. These findings emphasize the critical role of utility prices in evaluating the economic viability of CHP and TESSH systems under different market conditions.

### DISCUSSION

The results presented in this study are specific to a single case study with unique parameters and inputs and are not intended to be broadly representative of all CEA facilities. The value of the case study is in its demonstration of the model's capability to help site managers compare the effectiveness of various technology combinations and to optimize operation of site to meet operational goals. Further research and site-specific studies must be done to determine how different equipment characteristics, market prices, and operational constraints may impact optimal operation at CEA sites.

The results that can be produced by the model, as shown by the case study, offer valuable insights for CEA managers, designers, and policymakers. From an operational perspective, integrating an energy dispatch optimizer can enhance cost efficiency while automating scheduling responsibilities, reducing the burden on growers. However, successful implementation requires robust measurement and communication networks to monitor real-time and forecasted demand and energy prices, as well as automated control capabilities to dynamically adjust system operations.

From a design standpoint, it is important to recognize that optimal operation may deviate significantly from traditional load-following CHP strategies. For instance, in the case study, thermal storage is utilized more in the spring and fall than in winter, contrary to conventional expectations. This highlights the importance of data-driven investment decisions, where understanding the frequency and timing of a technology's contribution to cost savings can aid in sizing, maintenance planning, and capital investment strategies.

Despite its advantages, the optimization framework presented in this study does not account for all economic factors that influence investment decisions. Capital and maintenance costs are critical considerations when evaluating energy technologies, and demand charges often represent a significant portion of electricity costs for consumers. While optimized energy management provides a clearer picture of potential efficiency gains, a more comprehensive assessment of economic feasibility would require incorporating life-cycle cost analysis, including annualized capital expenditures, maintenance costs, and managerial overhead. Expanding this research to integrate such financial considerations could further clarify the long-term investment value of various technologies, providing decision-makers with a more holistic view of cost-effectiveness.

Future enhancements to the model could include integrating energy demand forecasting to explore synergies between demand shifting and optimized generation and management, unlocking additional cost savings. Moreover, incorporating demand response participation could introduce new revenue opportunities, making dynamic energy management a more attractive strategy for CEA facilities.

While this study focuses on operational energy costs and emissions, it is important to consider the broader sustainability context of CEA systems. Achieving a truly sustainable food production model requires attention to additional factors such as water usage, local air quality, and community engagement, which are beyond the scope of this analysis. Future research could explore the social and environmental dimensions of CEA, including the potential impacts on water conservation, air pollution reduction, and local food system resilience. Additionally, integrating other sustainable practices such as renewable energy sources, rainwater harvesting, greywater recycling, and biodiversity support could further enhance the environmental and economic benefits of CHP systems in CEA.

### CONCLUSIONS

Controlled environment agriculture offers sustainable solutions to many challenges in today's food systems, but its high energy demands pose a significant obstacle. Combined heat and power systems provide reliable and efficient energy production that aligns well with the diverse energy needs of CEA, creating optimal conditions for plant growth. Cogeneration systems can be enhanced with auxiliary technologies such as thermal storage, batteries, absorption chillers, and carbon capture systems. The model presented in this paper demonstrates optimal energy dispatch strategies, enabling multi-objective optimization for minimizing energy costs and emissions while integrating CHP with various auxiliary technologies. As grid decarbonization advances and smart grid and microgrid technologies develop, these systems can have an even greater impact on operational outcomes. Additionally, selling electricity can provide a supplementary revenue stream for CEA operators and enhance energy resiliency for the broader grid. The model can support developers in designing more effective energy systems tailored to their goals and assist operators in optimizing performance in real-time. The case study demonstrates the model's capabilities and highlights how it enables dynamic decision-making to improve CEA operations under different external conditions and technology configurations. The introduction of CHP reduced procurement costs by 12.48%, with an additional 6.46% savings achieved through the integration of thermal storage for heating. Furthermore, selling electricity demonstrated potential for up to a 7.05% reduction in net costs in a scenario that combined thermal storage and battery storage. Future research could explore the inclusion of demand response strategies at CEA sites or further evaluate the financial benefits of using dispatchable energy resources to meet capacity concerns on the macro-grid. Investigating additional technologies such as biogas, heat pumps, and geothermal energy could further support decarbonization efforts in the CEA industry. Finally, co-locating CEA facilities with other industries to enhance efficiency and resource utilization offers another promising avenue for advancing the sector.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the endpoints. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. An energy management and optimization system for a controlled environment agriculture (CEA) facility, the system comprising:
at least one combined heat and power (CHP) unit that produces electricity, thermal energy, and carbon dioxide (CO₂) exhaust from a fuel source;
a plurality of auxiliary technologies comprising:
a thermal energy storage system configured to receive, store, and discharge thermal energy,
a battery energy storage system configured to receive, store, and discharge electricity,
a chiller configured to convert thermal energy and/or electricity into cooling energy,
a cooling energy storage system configured to receive, store, and discharge cooling energy,
an exhaust aftertreatment unit configured to receive and treat the CO₂ exhaust, and to discharge treated CO₂, and
a carbon capture and utilization system configured to receive, store, and discharge the treated CO₂ exhaust; and
a control system in communication with the CHP unit and the auxiliary technologies,
wherein the CEA facility receives thermal energy, cooling energy, electricity, and CO₂ from the system, and
wherein the control system receives inputs, executes a multi-objective optimization algorithm, and generates control signals to operate the CHP and auxiliary systems.

2. The system of claim 1, further comprising:
an electrical grid configured to supply electricity to the CEA facility and/or the battery energy storage system.

3. The system of claim 2, wherein the electrical grid is configured to receive electricity from the battery energy storage system.

4. The system of claim 1, wherein the multi-objective optimization algorithm comprises a multi-objective mixed-integer linear programming (MILP) model.

5. The system of claim 1, wherein the MILP model:
collects demand inputs of thermal energy, cooling energy, electricity, and CO₂ for the CEA facility,
collects market data,
collects real-time operational data from the CHP unit and auxiliary technologies, and
determines control signals to operate the CHP unit and the auxiliary technologies based on an objective function.

6. The system of claim 5, wherein the market data includes one or more selected from the group consisting of market cost of electricity, market price for electricity to be sold, market cost of CO₂, market price for CO₂ to be sold, market cost of the fuel source, and market price for thermal energy to be sold.

7. The system of claim 5, wherein the objective function is:
$$min {\sum }_{t = {t}_{i}}^{{t}_{f}} ( {w}_{cost} \cdot {Cost}_{net} [ t ] + {w}_{emissions} \cdot {Emissions}_{total} [ t ] )$$
wherein t is time, tᵢ is an initial time, t_{f} is a predefined final time, w_{cost} is a predefined weight assigned to total costs, Wₑₘᵢₛₛᵢₒₙₛ is a predefined weight assigned to total emissions, Costₙₑₜ is total costs, and Emissionsₜₒₜₐₗ is total emissions.

8. The system of claim 7, wherein the total costs are determined by:
$${Cost}_{net} [ t ] = {Cost}_{N G} [ t ] + {Cost}_{E} [ t ] + {Cost}_{CO 2} [ t ] - Sales [ t ]$$
wherein COSt_{NG} is a cost of the fuel source, COSt_{E} is a cost of the electricity, Cost_{CO2} is a cost of the carbon dioxide, and Sales[t] is a market price at which electricity is sold multiplied by exported electricity.

9. The system of claim 7, wherein the total emissions are determined by:
$${Emissions}_{Total} [ n ] = {Emissions}_{O nsite} [ t ] + {Emissions}_{Grid} [ t ] + {Emissions}_{CO 2 Buy} [ t ]$$
wherein Emissions_{Onsite} is CO₂ produced from the CHP unit, Emissions_{Grid} is CO₂ produced from an electrical grid, and Emissions_{CO2Buy} is CO₂ purchased from an external source.

10. The system of claim 5, wherein the MILP model dynamically adjusts the control signals based on the real-time operational data.

11. The system of claim 1, further comprising:
a boiler configured to generate electricity and thermal energy from the fuel source.

12. The system of claim 1, wherein the chiller comprises:
an absorption chiller configured to convert thermal energy into cooling energy; and/or
an electric chiller configured to convert electrical energy into cooling energy.

13. The system of claim 1, further comprising:
a secondary facility that generates thermal energy.

14. The system of claim 13, further comprising:
a waste heat recovery heat pump configured to recover thermal energy from the secondary facility,
wherein the recovered thermal energy is supplied to the thermal energy storage system and/or the CEA facility.

15. The system of claim 13, wherein the secondary facility receives cooling energy and/or electricity from the system.

16. The system of claim 13, wherein the secondary facility is a data center.
